(19) United States
(12) Patent Application Publication
(10) Pub. No.: US 2009/0019235 A1
(43) Pub. Date: Jan. 15, 2009

(54) APPARATUS AND METHOD FOR CACHING DATA IN A COMPUTER MEMORY

(76) Inventors: Nobuyuki Harada, Tokyo (JP); Takeo Nakada, Kawaguchi-shi (JP)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 12/172,553

(22) Filed: Jul. 14, 2008

(30) Foreign Application Priority Data
Jul. 13, 2007 (JP) 2007-184806

(51) Int. Cl. G06F 12/08

(52) U.S. Cl. 711/143; 711/118; 711/E12.026; 711/E12.017

(57) ABSTRACT

A memory apparatus that exclusive ORs, for validity data having an array of logical values indicative of whether the sectors are valid, each bit of the validity data with the next bit, masks a bit string having an array of the exclusive ORs except the first bit of bits whose logical values are true in a preset detection range, detects the position of a bit whose logical value is true in the masked bit string, and every time the bit position is detected, executes the process of setting the bit position adjacent to the end with respect to the bit position as the detection range and repeats it until no bit position is detected, calculates the address of the main memory corresponding to each area of consecutive invalid sectors according to the bit position detected in sequence, issues a read command to the calculated address, and writes back the cache segment.

### FIELD OF THE INVENTION

The field of the invention relates to a technique for caching data, and more particularly, to a technique for caching data to be written into a main memory.

### BACKGROUND OF THE INVENTION

Semiconductor disk devices using a flash memory, typified by a USB memory, are widely used in recent years.

Semiconductor disk devices have been increasingly required to have high capacity, high speed, and low power consumption with an expansion in application. Flash memories have different characteristics from those of DRAMs in some cases. For example, on writing data into a NAND-type flash memory, an area into which data is to be written has to be erased. The erasing process requires a long time as compared with a read operation. Moreover, flash memories cannot be used when the number of accesses reaches a specified limit.

To cope with such characteristics of flash memories, it is desirable to implement the capability of simultaneous access. For example, access commands to write to a flash memory are temporarily stored in a buffer, and a plurality of write commands to one sector are combined into one write command, and then issued to the flash memory. However, the amount of data to be written changes from one write command to the next. Therefore, it is difficult to make effective use of the storage capacity of a buffer so as to store a large number of commands efficiently.

Furthermore, a technique for implementing cache memory dedicated to a CPU may be applied to execute a simultaneous, multiple access. However, the technique for CPUs is directed purely to high-speed access, so that it cannot sufficiently decrease the number of memory accesses to the main memory, and so cannot be applied to flash memories. A circuit for controlling cache processing is required to achieve space saving and power saving, as is realized for cache memory of CPUs. Accordingly, it is desirable to reduce the circuit size and power consumption, in addition to increasing access speed and decreasing access times.

Accordingly, it is an object of the invention to provide a memory apparatus in which the above described drawbacks are overcome, and a method and a program for the same. The object is attained by combinations of the features described in the independent claims. The dependent claims specify further advantageous examples of the invention.

### SUMMARY OF THE INVENTION

To solve the above problems, according to a first aspect of the invention, there is provided a memory apparatus that caches data to be written into a main memory. The memory apparatus includes: a cache memory including a plurality of cache segments, and storing, for each cache segment, validity data having logical values arrayed in order of the sectors contained in each cache segment, the logical values each indicating whether or not each sector is a valid sector inclusive of valid data; a calculating component for calculating, when writing back a cache segment into the main memory, the address of the main memory corresponding to each area having consecutive invalid sectors according to validity data corresponding to the cache segment; and a write-back controlling component issuing a read command to read data from the address of the main memory to each area of consecutive invalid sectors, and making the area a valid sector, and writing back the data in the cache segment into the main memory. The calculating component includes: an exclusive-OR operating section for exclusive ORing each bit of a bit string indicative of the validity data with the next bit; a bit mask section for masking the bit string having an array of the exclusive ORs except the first bit of bits whose logical values are true in a preset detection range; a bit-position detecting section for detecting the position of a bit whose logical value is true in the masked bit string; a controller setting, every time the bit position is detected, a bit position adjacent to the end with respect to the bit position to the bit mask section as the detection range, and repeating the process until no bit position is detected; and an address calculating section for calculating the address of the main memory corresponding to each area of consecutive invalid sectors according to the bit position detected in sequence. There are also provided a method and a program for controlling the memory apparatus.

The outline of the invention does not include all the necessary features of the invention but subcombinations of the features may also be included within the scope of the invention.

### BRIEF DESCRIPTION OF THE DRAWINGS

Referring to the exemplary drawings wherein like elements are numbered alike in the several Figures:

FIG. 1 shows an example of the hardware structure of a computer 10 according to an embodiment.

FIG. 2 shows an example of the hardware structure of a memory apparatus 20 according to the embodiment.

FIG. 3 shows an example of the data structure of a main memory 200 according to the embodiment.

FIG. 4 shows an example of the data structure of a cache memory 210 according to the embodiment.

FIG. 5 shows an example of the data structure of tag information 310 according to the embodiment.

FIG. 6 shows concrete examples of a cache segment 300 and a validity data field 410 according to the embodiment.

FIG. 7 shows the functional structure of a cache controlling component 220 according to the embodiment.

FIG. 8 shows the functional structure of a calculating component 720 according to the embodiment.

FIG. 9 shows the functional structure of a bit-position detecting section 820 according to the embodiment.

FIG. 10 shows the process flow of the cache controlling component 220 according to the embodiment in response to requests from a CPU 1000.

FIG. 11 shows the details of the process in step S1030.

FIG. 12 shows the details of the process in steps S1050 and S1105.

FIG. 13 shows the details of the process in step S1200.

FIG. 14 shows the details of the process in step S1340.

FIG. 15 shows the details of the process for certain validity data in step S1300.

FIG. 16a shows the details of steps S1320 to S1340 of the first process of the validity data.

FIG. 16b shows the details of step S1340 of the first process of the validity data.

FIG. 17 shows the details of steps S1320 to S1340 of the second process of the validity data.

FIG. 18 shows the details of steps S1320 to S1340 of the third process of the validity data.

FIG. 19 shows the details of steps S1320 to S1340 of the fourth process of the validity data.

FIG. 20 shows the details of steps S1320 to S1340 of the fifth process of the validity data.

FIG. 21 shows a concrete example of the circuit structure of the calculating component 720 according to the embodiment.

FIG. 22 shows a concrete example of an area of consecutive invalid sectors, detected from validity data.

FIG. 23 shows the functional structure of a first modification of the calculating component 720 according to the embodiment.

FIG. 24 shows the process flow of the calculating component 720 according to the first modification of the embodiment.

### DETAILED DESCRIPTION OF THE INVENTION

The invention will be further illustrated with reference to preferred embodiments. However, it is to be understood that the embodiments do not limit the invention according to the claims and that all the combinations of the features described in the embodiment are not essential to achieve the object.

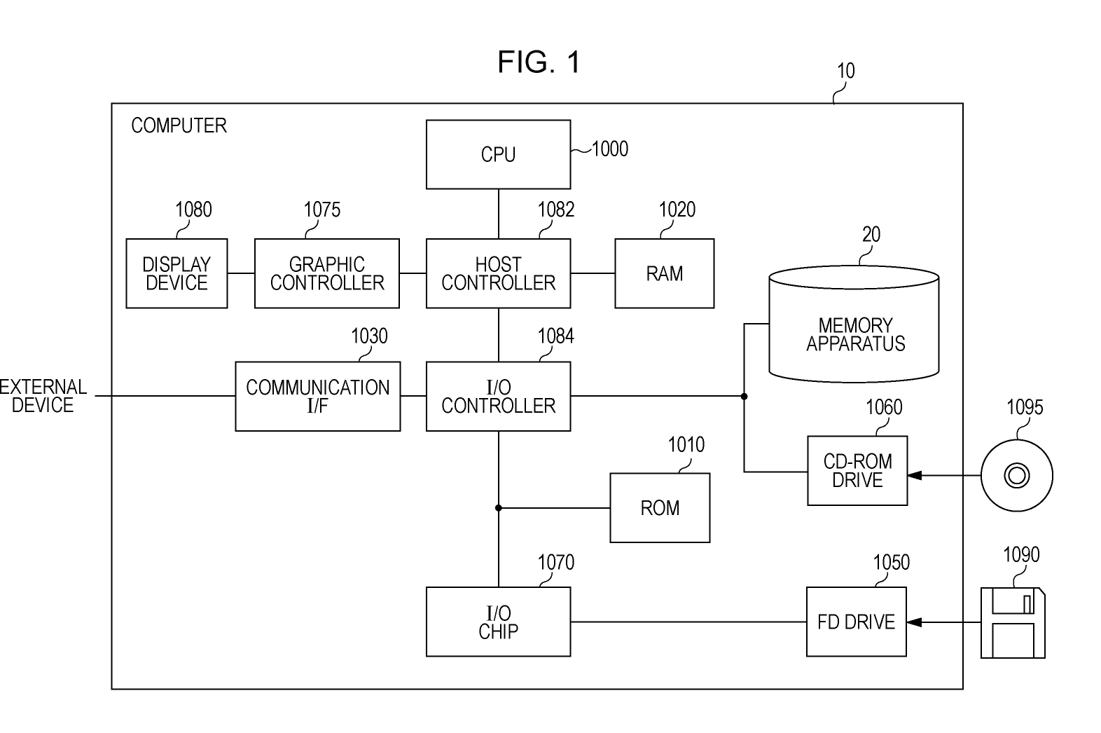

FIG. 1 shows an example of the hardware structure of a computer 10 according to an embodiment. The computer 10 includes a CPU 1000 and CPU peripherals including a RAM 1020 and a graphics controller 1075, which are connected to each other by a host controller 1082. The computer 10 further includes a communication interface 1030, a memory apparatus 20, and an input/output section including a CD-ROM drive 1060 which are connected to the host controller 1082 via an input/output controller 1084. The computer 10 may further include a ROM 1010 connected to the input/output controller 1084 and a legacy input/output section including a flexible disk drive 1050 and an input/output chip 1070.

The host controller 1082 connects the RAM 1020 to the CPU 1000 which has access to the RAM 1020 at a high transfer rate and the graphics controller 1075. The CPU 1000 operates according to programs stored in the ROM 1010 and the RAM 1020 to control the components. The graphic controller 1075 obtains image data that the CPU 1000 and the like generates on a frame buffer in the RAM 1020, and displays it on a display 1080. Instead, the graphic controller 1075 may have therein the frame buffer to store the image data generated by the CPU 1000 and the like.

The input/output controller 1084 connects the host controller 1082 to the communication interface 1030 which is a relatively high-speed input/output device, the memory apparatus 20, and the CD-ROM drive 1060. The communication interface 1030 communicates with an external device via a network. The memory apparatus 20 stores programs and data that the computer 10 uses. The memory apparatus 20 may be a volatile memory device, for example, a flash memory or a hard disk drive. The CD-ROM drive 1060 reads programs or data from the CD-ROM 1095 and provides them to the RAM 1020 or the memory apparatus 20.

The input/output controller 1084 connects to the ROM 1010 and relatively low-speed input/output devices including the flexible disk drive 1050 and the input/output chip 1070. The ROM 1010 stores a boot program executed by the CPU 1000 to start the computer 10, programs that depend on the hardware of the computer 10, and so on. The flexible disk drive 1050 reads a program or data from the flexible disk 1090, and provides it to the RAM 1020 or the memory apparatus 20 via the input/output chip 1070. The input/output chip 1070 connects to the flexible disk 1090 and various input/output devices via, for example, a parallel port, a serial port, a keyboard port, and a mouse port.

Programs for the computer 10 are stored in a recording medium such as the flexible disk 1090, the CD-ROM 1095, or an IC card and are provided to the user. The programs are read from the recording medium via the input/output chip 1070 and/or the input/output controller 1084, and are installed into the computer 10 for execution. The programs may be executed by the CPU 1000 or the microcomputer in the memory apparatus 20 to control the components of the memory apparatus 20. The foregoing programs may be stored in external storage media. Examples of the storage media are, in addition to the flexible disk 1090 and the CD-ROM 1095, optical record media such as DVDs and PDs, magnetooptical record media such as MDs, tape media, semiconductor memories such as IC cards.

While the embodiment uses the computer 10 as a system equipped with the memory apparatus 20 as an example, the memory apparatus 20 may be provided to any other units or systems. The memory apparatus 20 may be provided to portable or mobile units such as USB memory devices, portable phones, PDAs, audio players, and car navigation systems or desktop units such as file servers and network attached storages (NASs).

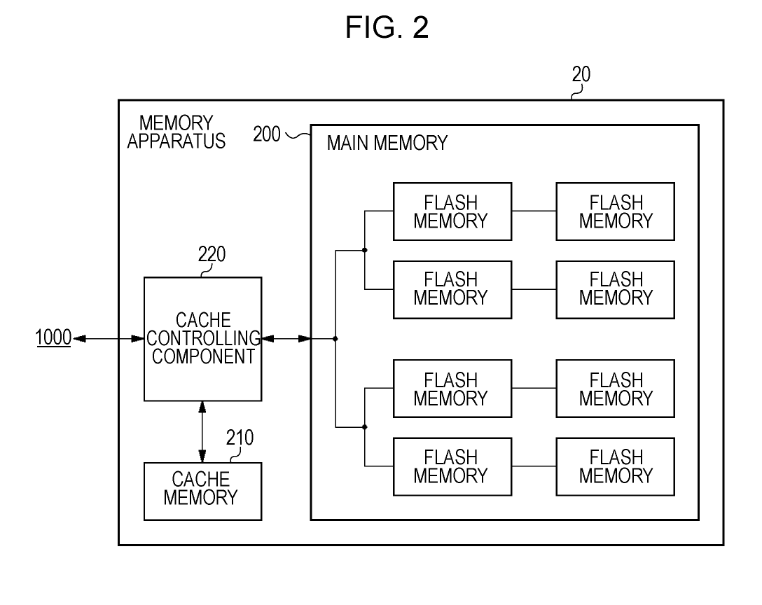

FIG. 2 shows an example of the hardware structure of the memory apparatus 20 according to this embodiment. The memory apparatus 20 includes a main memory 200, a cache memory 210, and a cache controlling component 220. The main memory 200 is a nonvolatile memory medium capable of holding stored contents even if the power supply to the computer 10 is shut off. Specifically, the main memory 200 may include at least one flash memory. Instead, or in addition to that, the main memory 200 may include at least one of a hard disk drive, a magnetooptical disk drive and an optical disk, and a tape drive and a tape. In the case where the main memory 200 includes a flash memory, it is desirable that the number of flash memories is two or more. This can increase not only the memory capacity of the main memory 200 but also the throughput of data transfer by interleaving.

The cache memory 210 is a volatile storage medium that loses its memory contents when the power source of the computer 10, for example, is shut off. Specifically, the cache memory 210 may be an SDRAM. The cache controlling component 220 receives a request to access the main memory 200 from the CPU 1000. More specifically, the cache controlling component 220 receives a request that is output from the input/output controller 1084 according to the instruction of a program that operates on the CPU 1000. This request may comply with a protocol for transferring the request to the hard disk drive, such as an AT attachment (ATA) protocol or a serial ATA protocol. Instead, the cache controlling component 220 may receive the request in accordance with another communication protocol.

When the request received is a read request, the cache controlling component 220 determines whether the requested data is stored in the cache memory 210. If it is stored, the cache controlling component 220 reads the data and sends a reply to the CPU 1000. If it is not stored, the cache controlling component 220 reads the data from the main memory 200 and sends a reply to the CPU 1000. In contrast, the received request is a write request, the cache controlling component 220 determines whether a cache segment for caching the write data is assigned to the cache memory 210. If it is assigned, the cache controlling component 220 writes the write data thereto. The cache segment into which the write data is written is written back to the main memory 200 if predetermined conditions are met. On the other hand, if the cache segment is not assigned, the cache controlling component 220 assigns a new cache segment to cache the write data. Thus, the cache controlling component 220 acts to control access to the cache memory 210.

An object of the embodiment is to solve the significant problems of this data cache technique which arise when a flash memory is used as the main memory 200, thereby enabling efficient access to the memory apparatus 20. Specific descriptions will be given hereinbelow.

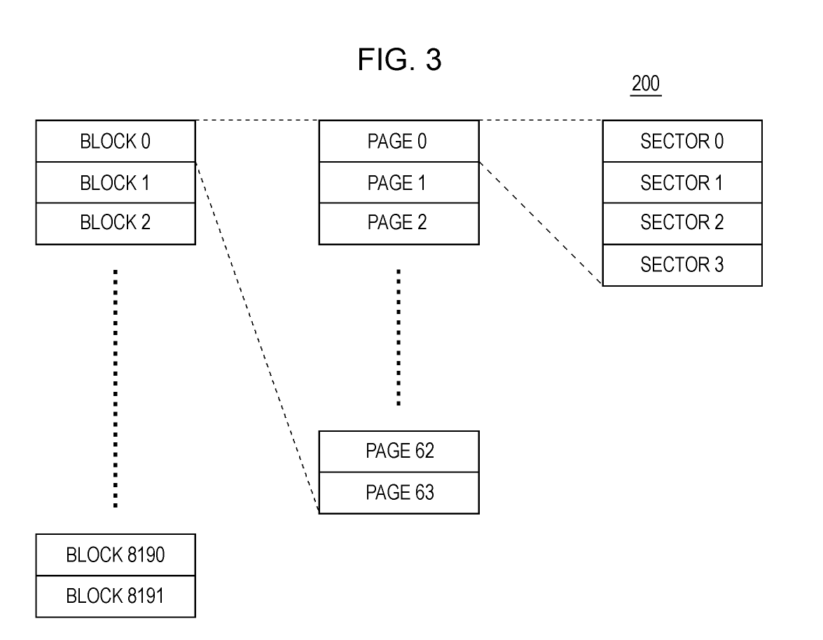

FIG. 3 shows an example of the data structure of the main memory 200 according to the preferred embodiment. The main memory 200 includes a plurality of, for example, 8,192 memory blocks. The memory block is the smallest unit of write data written to the main memory 200. That is, even data blocks smaller than one memory block is written to the main memory 200 on a memory block basis. Accordingly, to write a small amount of data, after the entire target memory blocks are read from the main memory 200, the read data is updated according to the write data, and then the updated data is written to the main memory 200.

Only one of a change from a logical value of true 1 to a logical value of false 0 and a change from a logical value of false 0 to a logical value of true 1 can be sometimes made in a unit smaller than the memory block. However, it is extremely rare that data writing is achieved under such circumstances. Therefore, it is necessary to write data to the memory block after the data of the entire memory block selected has been erased. With the exception of such a rare case, data is erased on a memory block basis. Therefore, data writing is also often made substantially on a memory block basis. Thus, writing and erasing can be considered to be substantially the same in this embodiment, although strictly speaking their concept and unit are different. Accordingly, a process called “writing” or “writing back” in this embodiment can include the process of erasing unless otherwise specified.

The memory blocks each include a plurality of pages, for example, 64 pages. The page is the unit of data writing (writing without erasing) and the unit of data reading. For example, one page in a flash memory has 2,112 bytes (2,048 bytes+64 bytes of a redundant section). The redundant section is an area for storing an error correcting code or an error detecting code. Although reading can be achieved in a unit smaller than that of writing, the page that is the unit of reading has a certain degree of data size. Therefore, it is desirable to read data of a certain degree of data size in one go. A read-only cache memory may be provided in the main memory 200 to increase the efficiency of reading. Also in that case, it is desirable that addresses of data to be read continue to a certain extent.

One page includes four sectors. The sector is fundamentally the memory unit of a hard disk drive used in place of the memory apparatus 20. In this embodiment, since the memory apparatus 20 is operated as if it were a hard disk drive, the memory apparatus 20 has a memory unit of the same size as a sector of the hard disk drive. In this embodiment, the memory unit is referred to as a sector. For example, one sector contains 512-byte data. Although the terms, block, page, and sector indicate a memory unit or storage area, they are also used to indicate data stored in the area for simplification of expression.

Although the main memory 200 has the above internal structure, it is desirable to be accessible from an external device in the unit of sectors for compatibility with the interface of the hard disk drive. For example, the main memory 200 may receive a read command to read data from Q sectors from the P^{th} sector. Parameters P and Q may be set for each command. Even if the main memory 200 can accept such commands, the processing speed corresponding thereto depends on the internal structure. For example, a command to read a plurality of consecutive sectors is faster in processing speed per sector than a command to read only one sector. This is because reading is achieved in the unit of page in view of the internal structure.

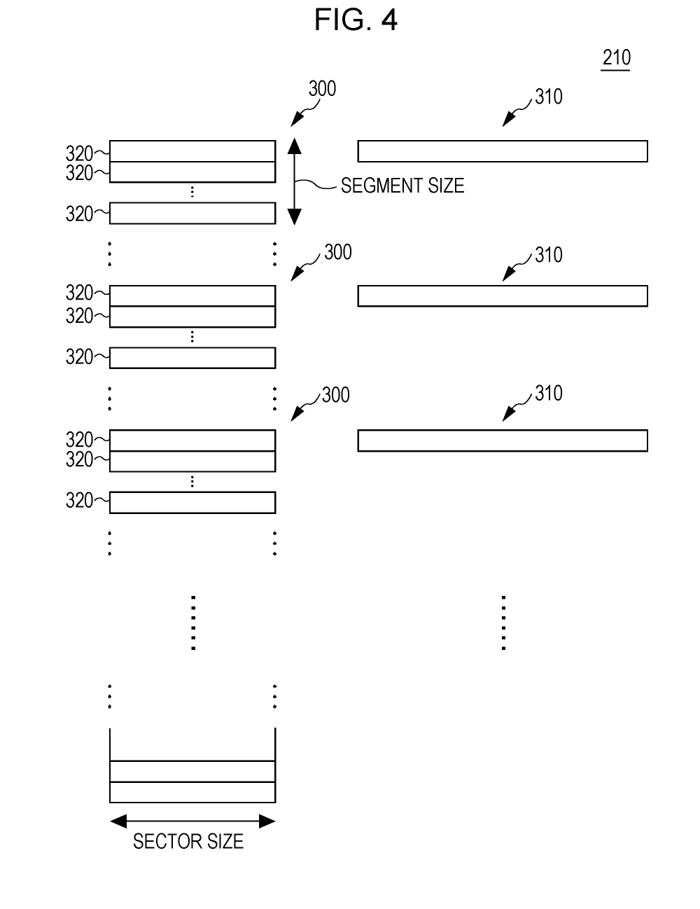

FIG. 4 shows an example of the data structure of the cache memory 210 according to this embodiment. The cache memory 210 has a plurality of segments 300. The cache memory 210 stores tag information 310 indicative of the respective attributes of the segments 300. The segments 300 each have a plurality of sectors 320. The sectors 320 are areas each having the same storage capacity as that of the sectors in the memory apparatus 20. The segment 300 can be assigned to at least part of the memory blocks of a data size larger than the cache segment. The assigned segments 300 read and store data in advance that is stored in part of the corresponding memory blocks to increase the efficiency of the following read processing. Instead, the assigned segments 300 may temporarily store data to be stored in part of the corresponding memory blocks to write them in a lump thereafter.

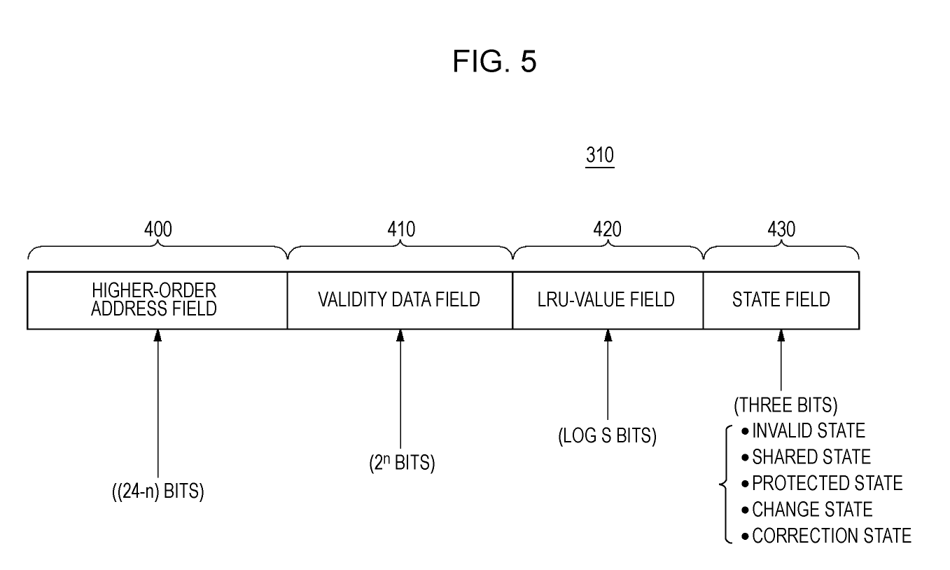

FIG. 5 shows an example of the data structure of the tag information 310 according to this embodiment. The cache memory 210 includes, as data fields for storing the tag information 310, a higher-order address field 400, a validity data field 410, an LRU-value field 420, and a state field 430. The higher-order address field 400 stores address values of predetermined digits from the highest order of the address values of the block in the main memory 200 to which a corresponding cache segment 300 is assigned. For example, when the addresses in the main memory 200 are expressed in 24 bits, the higher (24−n) bit address values except the lower n bits are stored in the higher-order address field 400. These address values are referred to as higher-order addresses or higher-order address values. Addresses except the higher-order addresses are referred to as lower-order addresses or lower-order address values.

When the higher-order address values are expressed as (24−n) bits and each sector can be defined uniquely by a lower-order address value, the number of the sectors 320 contained in one cache segment 300 is the n^{th} power of 2. Accordingly, whether or not each sector 320 contained in one cache segment 300 is a valid sector containing valid data can be expressed by a logical value of one bit. Accordingly, whether the plurality of sectors 320 contained in the segment 300 are valid sectors is expressed by 2ⁿ bits. Data in which these logical values are arrayed in order of the sector arrangement is referred to as validity data. The validity data field 410 stores the validity data. The LRU-value field 420 is a field for storing LRU values. The LRU value is an index indicative of an unused period as the name Least Recently Used suggests.

Specifically, the LRU value may indicate the unused period of a corresponding cache segment 300 from the longest to shortest or from the shortest to longest. Here the “use” means that at least one of reading and writing by the CPU 1000 is executed. More specifically, when a plurality of cache segments 300 is arranged from the longest to shortest or from the shortest to longest, the upper limit of the LRU value is the number of the cache segments 300. Accordingly, the LRU-value field 420 that stores the LRU values needs bits corresponding to the logarithm of the number S of segments whose lower limit is 2.

The state field 430 stores states set for corresponding cache segments 300. The states are expressed in, for example, three bits. Each cache segment 300 is set to any of a plurality of states including an invalid state, a shared state, a protected state, a change state, and a correction state. The outline of the states is as follows: The invalid state indicates the state of the cache segment 300 in which all the contained sectors 320 are invalid sectors. The invalid sectors hold no data that matches the main memory 200 and no data requested from the CPU 1000 to be written into the main memory 200. In the initial state in which the computer 10 is started or the like, all the cache segments 300 are in the invalid state.

The shared state is a state of the cache segment 300 in which all the sectors 320 are shared sectors and are replaceable for writing. The shared sectors are valid sectors and hold data that matches the main memory 200. The protected state indicates the state of the segment 300 in which all the sectors 320 are shared sectors and protected from writing. The change state and the correction state are states including data not matching the main memory 200 and to be written to the main memory 200. The cache segment 300 before being updated has data to be written to the main memory 200 in part of the sectors 320. In contrast, the cache segment 300 in the correction state has data to be written to the main memory 200 in all the sectors 320 thereof. Such sectors 320 are referred to as change sectors. The change sectors are valid sectors.

Those skilled in the art will appreciate techniques defining the state of cache segments for transition include, for example, an MSI protocol, an MESI protocol, and an MOESI protocol.

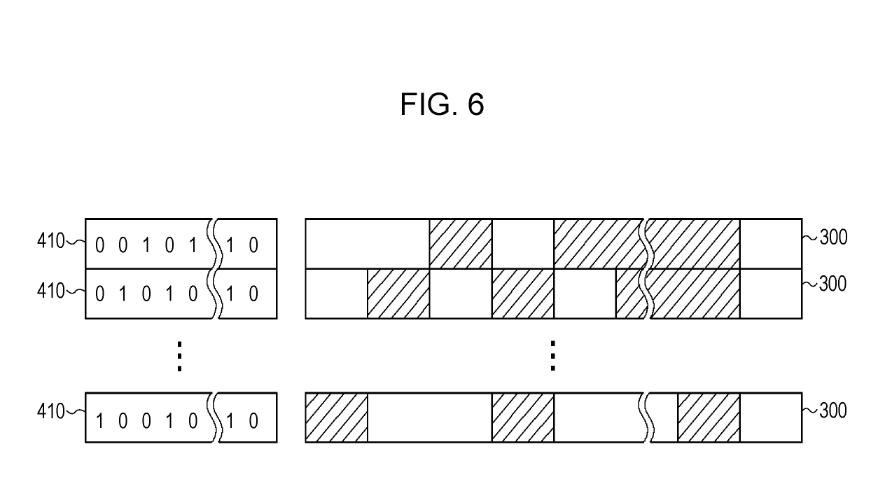

FIG. 6 shows concrete examples of the cache segment 300 and the validity data field 410 according to this embodiment. As in the change state, part of the cache segments 300 sometimes has a valid sector. FIG. 6 shows valid sectors by hatch lines. Invalid sectors are not given hatch lines. Validity data stored in the validity data filed 410 is a bit string in which logical values indicative of whether the sectors of a corresponding cache segment are valid or not and are arrayed for each sector. For example, a logical value 1 indicates a valid sector, and a logical value 0 indicates an invalid sector. Validity data has such logical values arrayed in order of corresponding sectors.

As described above, the position of each sector in the cache segment is uniquely defined by the address of the sector. If a cache miss occurs in writing, it is preferable that write data be written into the cache memory 210 without reading data from the main memory 200 into the cache memory 210 from the viewpoint of decreasing access to the flash memory. Accordingly, if a number of writing requests is given to various addresses, the cache segment may sometimes have valid sectors and invalid sectors discretely. In this case, validity data stored in the validity data field 410 has a logical value 1 and a logical value 0 discretely.

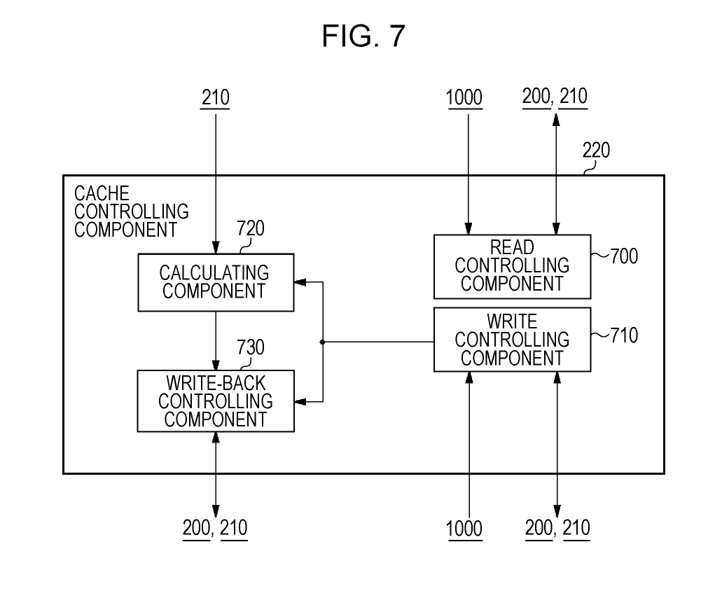

FIG. 7 shows the functional structure of the cache controlling component 220 according to the embodiment. The cache controlling component 220 has a basic function of converting a communication protocol such as an ATA protocol to a command for accessing the main memory 200, which could be a flash memory, and transmitting to the main memory 200. In addition, the cache controlling component 220 acts to improve the function of the whole memory apparatus 20 by controlling access to the cache memory 210. Specifically, the cache controlling component 220 includes a read controlling component 700, a write controlling component 710, a calculating component 720, and a write-back controlling component 730. The foregoing components may be achieved by various LSIs such as a hard-wired logic circuit and a programmable circuit, or may be achieved by a microcomputer that executes a program that is read in advance.

The read controlling component 700 receives a data read request to specific sectors from the CPU 1000. When the reading hits a cache, the read controlling component 700 reads the data from the cache memory 210 and sends a reply to the CPU 1000. If the reading misses a cache, the read controlling component 700 reads a page containing the data from the main memory 200 and stores it in the cache memory 210, and sends the data to the CPU 1000. The determination of whether a cache hit or a cache miss has occurred is made by comparing the higher-order address of the address to be read with the higher-order address field 400 corresponding to each cache segment 300. If a corresponding higher-order address is present, it is determined to be a cache hit, while if no corresponding higher-order address is present, it is determined to be a cache miss. However, if the sector to be read is an invalid sector even if a corresponding higher-order address is present, it is determined to be a cache miss.

The write controlling component 710 receives a data write request to sectors from the CPU 1000. When the writing misses a cache, the write controlling component 710 assigns a new cache segment to cache the write data. The determination of whether a cache hit or a cache miss is similar to that of reading. That is, if a corresponding higher-order address is present, it is determined to be a cache hit, while if no corresponding higher-order address is present, it is determined to be a cache miss. However, unlike reading, even writing to an invalid sector is a cache hit. Assignment of a cache segment is achieved by storing the higher-order address of the addresses to be written into the higher-order address field 400 corresponding to the cache segment 300 to be assigned. Selection of a segment 300 to be assigned is made according to the state of each cache segment 300.

For example, if a segment 300 in an invalid state is present, the segment 300 is selected, and if a segment 300 in an invalid state is absent, a segment 300 in a shared state is selected. If there are two or more segments 300 in the same state, a segment 300 with the longest unused period indicated by an LRU value is selected therefrom. If there is no appropriate segment 300 to be selected, the write controlling component 710 instructs the write-back controlling component 730 to write back a specified segment 300 into the main memory 200, and selects the segment 300 for use as a new segment 300. The write controlling component 710 writes the write data into the sectors in the new segment 300, and sets validity data corresponding to the sectors other than the target sectors invalid.

On the other hand, if writing to one sector hits a cache, the write controlling component 710 writes the write data into the sector in the segment 300 assigned to cache the write data to the sector. The write controlling component 710 sets validity data corresponding to the sector validity. The written data is written back into the main memory 200 by the write-back controlling component 730 when there is no new segment 300 to be assigned or specified then these conditions are met.

The calculating component 720 starts processing when writing back a segment 300 into the main memory 200, and accesses validity data corresponding to the segment 300 to detect an area of consecutive invalid sectors. For example, the calculating component 720 detects a plurality of consecutive invalid sectors having no valid sectors in between as an area of consecutive invalid sectors. In addition, the calculating component 720 may detect one invalid sector between valid sectors as the area. The calculating component 720 calculates the address of the main memory 200 corresponding to each detected area.

The write-back controlling component 730 issues a read command to read data into each detected area to the main memory 200 and makes the areas valid sectors. To the read command, a reading range, for example, a sector position to start reading and the number of sectors to be read, can be set. That is, reading commands may be issued according to the number of the areas not the number of invalid sectors. The sector position to start reading and the number of sectors to be read are calculated from, for example, the address calculated by the calculating component 720. The write-back controlling component 730 writes back the data in the segment 300 filled with valid sectors into the main memory 200.

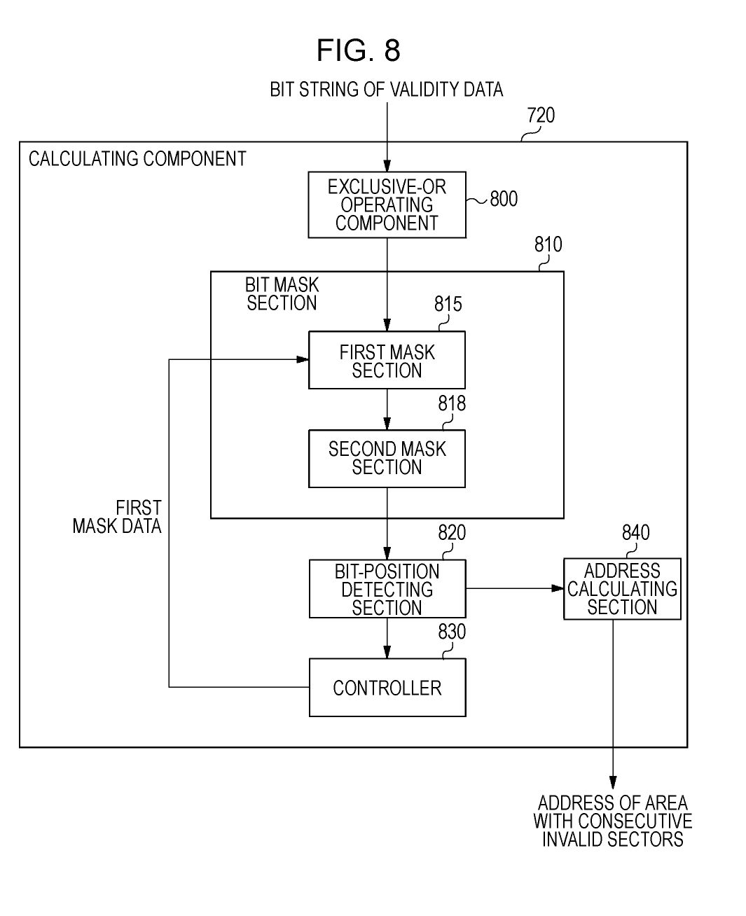

FIG. 8 shows the functional structure of the calculating component 720 according to the embodiment. The calculating component 720 includes an exclusive-OR operating section 800, a bit mask section 810, a bit-position detecting section 820, a controller 830, and an address calculating section 840. The exclusive-OR operating section 800 inputs a bit string representing validity data. The exclusive-OR operating section 800 exclusive ORs each bit of the bit string with the adjacent other bit. Specifically, the exclusive-OR operating section 800 first exclusive ORs the first bit of the bit string with a constant logical value of true, and disposes it at the first of the bit string indicative of the obtained exclusive ORs. The exclusive-OR operating section 800 then exclusive ORs another bit of the bit string representing validity data with the next bit adjacent to the end, and disposes it next to the first bit adjacent to the end in the bit string representing the obtained exclusive ORs.

The bit mask section 810 inputs the bit string in which the exclusive ORs are arrayed. The bit mask section 810 masks the bit string except the first bit of the bits of logical value true in a preset detection range. Specifically, the bit mask section 810 includes a first mask section 815 and a second mask section 818. The first mask section 815 masks bits outside the set detection range of the bit string having the exclusive OR array. The second mask section 818 masks the bits of the bit string masked by the first mask section 815 adjacent to the end with respect to the first bit having a logical value true.

The bit-position detecting section 820 detects the position of a bit of a logical value true in the masked bit string. Every time a bit position is detected with a logical value of true, the controller 830 repeats the process of setting the position of bits adjacent to the end with respect to the bit position to the bit mask section 810 as a detection range until no bit position is detected. Thus, the bit mask section 810 and the bit-position detecting section 820 output the detected bit positions to the address calculating section 840 in sequence. The address calculating section 840 calculates the address of the main memory 200 corresponding to each area of consecutive invalid sectors from the bit positions detected in sequence.

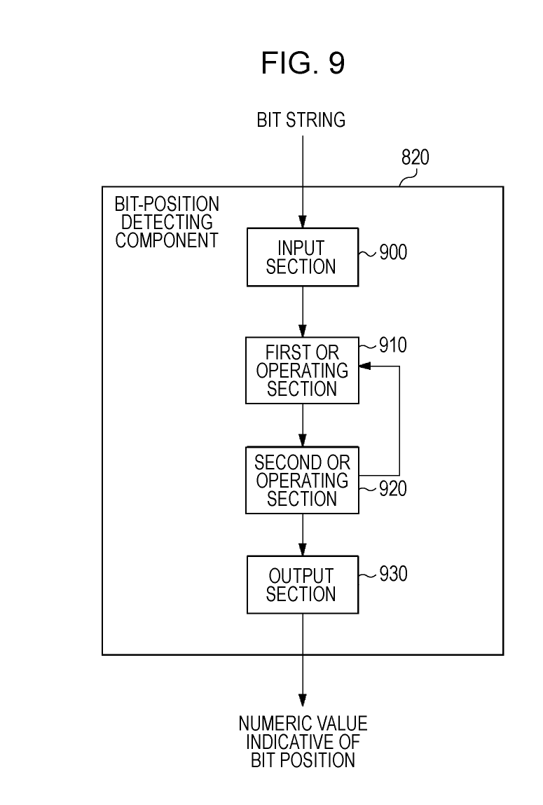

FIG. 9 shows the functional structure of the bit-position detecting section 820 according to the embodiment. The bit-position detecting section 820 includes an input section 900, a first OR operating section 910, a second OR operating section 920, and an output section 930. The input section 900 inputs a bit string masked by the bit mask section 810. The first OR operating section 910 ORs between the last bits of the two-split bit string input. The second OR operating section 920 ORs between the obtained Ors generated from section 910. Furthermore, the second OR operating section 920 splits the bit string input from the first OR operating section 910 into two strings, and outputs them to the first OR operating section 910. The second OR operating section 920 repeats the processes until the bit string input by the first OR operating section 910 cannot be split, that is, until the bit string contains only one bit. The output section 930 arrays the ORs calculated by the second OR operating section 920 from the higher-order digit in order of operation, and outputs them as numeric values indicative of bit positions to be detected.

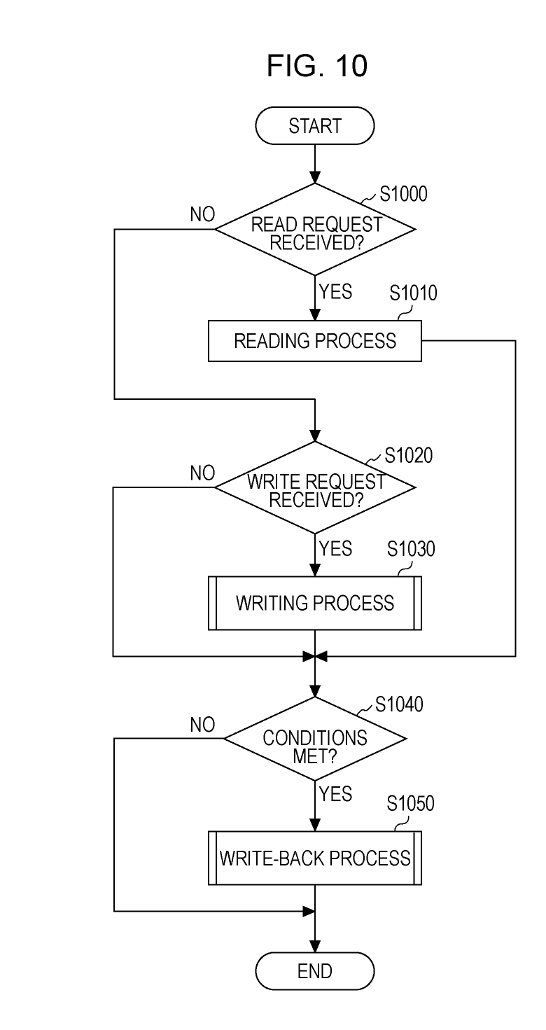

FIG. 10 shows the flow of the processing of the cache controlling component 220 of the embodiment in response to requests from the CPU 1000. Upon reception of a data read request to sectors from the CPU 1000 (S1000: YES), the read controlling component 700 executes reading process (S1010). For example, if the reading hits a cache, the read controlling component 700 reads the data from the cache memory 210 and sends the data to the CPU 1000. If the reading misses a cache, the read controlling component 700 reads a page containing the data from the main memory 200, stores it in the cache memory 210, and sends the data to the CPU 1000.

Upon receipt of a data write request to sectors from the CPU 1000 (S1020: YES), the write controlling component 710 executes writing process (S1030). The details will be described later with reference to FIG. 10. If predetermined conditions are met (S1040), the calculating component 720 and the write-back controlling component 730 write back a segment 300 having both valid sectors and invalid sectors into the main memory 200 (S1050). For example, the calculating component 720 and the write-back controlling component 730 select a segment 300 containing valid sectors and invalid sectors under the condition that the proportion of segments 300 containing both valid sectors and invalid sectors of the segment 300 in the cache memory 210 has exceeded a predetermined reference value, and writes it back to the main memory 200. It is desirable that the selection of the segment 300 is based on the LRU value. This secures a new segment 300 that can be assigned before the occurrence of a cache miss, thus reducing the time for processing at the occurrence of a cache miss.

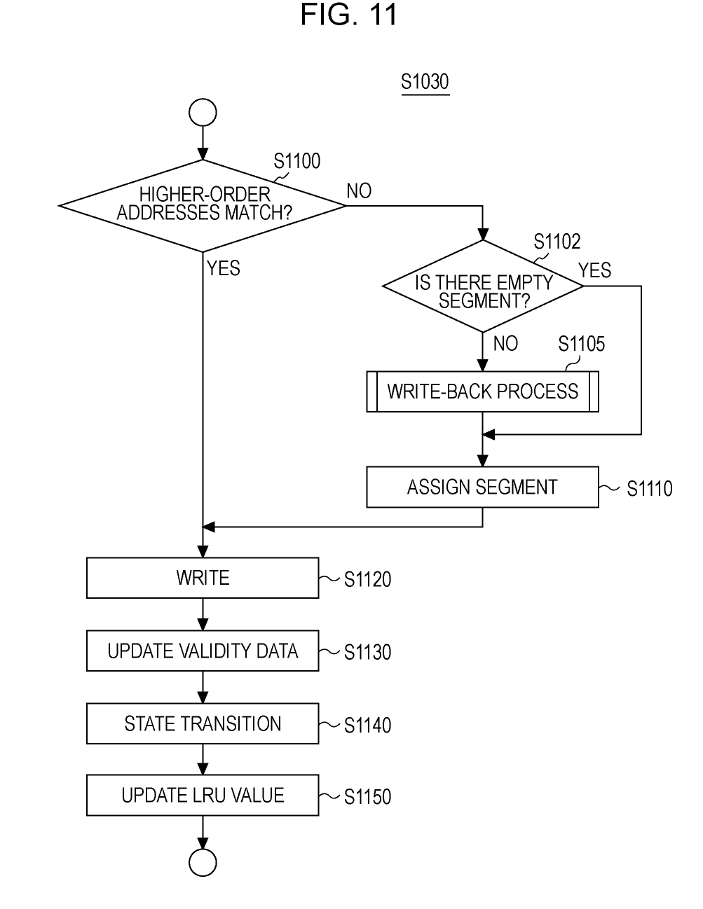

FIG. 11 shows the details of the process in step S1030. The write controlling component 710 determines whether the higher-order address of the address to which a write request is given matches a higher-order address stored in any of the higher-order address fields 400 (S1100). If they do not match (in the case of a cache miss, S1100: NO), the write controlling component 710 determines whether there is a new segment 300 that can be assigned to cache the write data (S1102). For example, the write controlling component 710 scans the state fields 430 to search for a segment 300 in an invalid state or in a shared state. This is because such segments 300 are reusable for another purpose without being written back to the main memory 200. If a segment 300 in any of the states is found, it is determined that a newly assignable segment 300 is present.

If there is no newly assignable segment 300 (S1102: NO), the calculating component 720 and the write-back controlling component 730 execute the process of writing back a segment 300 containing valid sectors and invalid sectors into the main memory 200 (S1105). The write controlling component 710 assigns a new segment 300 to cache the write data (S1110). After the segment 300 is assigned or at a cache hit in which higher-order addresses match (S1100: YES), the write controlling component 710 stores the write data in the newly assigned segment 300 or the segment 300 in which the higher-order addresses match (S1120). If data is written to the newly assigned segment 300, the write controlling component 710 sets validity data corresponding to sectors other than the target sector invalid (S1130). In the case of a cache hit, the write controlling component 710 sets the validity data corresponding to the written sector valid.

The write controlling component 710 may update a corresponding state field 430 so as to shift the state of the segment 300 to another state as necessary (S1140). The write controlling component 710 may update the LRU-value field 420 so as to change the LRU value corresponding to the write target segment 300 (S1150).

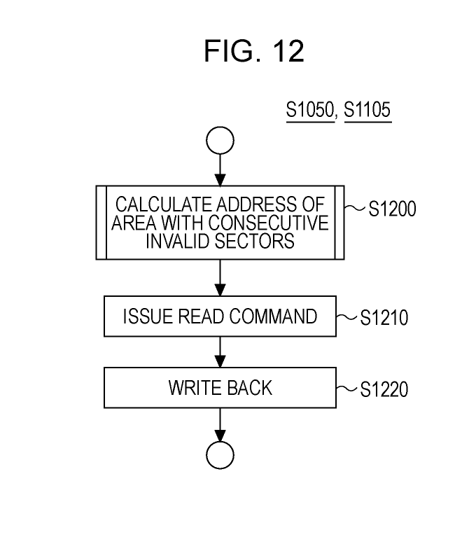

FIG. 12 shows the details of the processes in steps S1050 and S1105. The calculating component 720 and the write-back controlling component 730 execute the following process to write back a segment 300 into the main memory 200. First, the calculating component 720 calculates the address of the main memory 200 corresponding to each of areas of consecutive invalid sectors according to validity data corresponding to the segment 300 (S1200). The write-back controlling component 730 issues a read command to read data into each area of consecutive invalid sectors to the main memory 200, and makes the area a valid sector (S1210). The write-back controlling component 730 writes back the data in the segment 300 filled with valid sectors into the main memory 200 (S1220).

If one segment 300 is smaller in size than one memory block, the process of reading the other data in the memory block is also executed. For example, the write-back controlling component 730 reads the data corresponding to the other cache segment in the memory block from the main memory 200, and writes back the segment to be written back and the read data to the memory block.

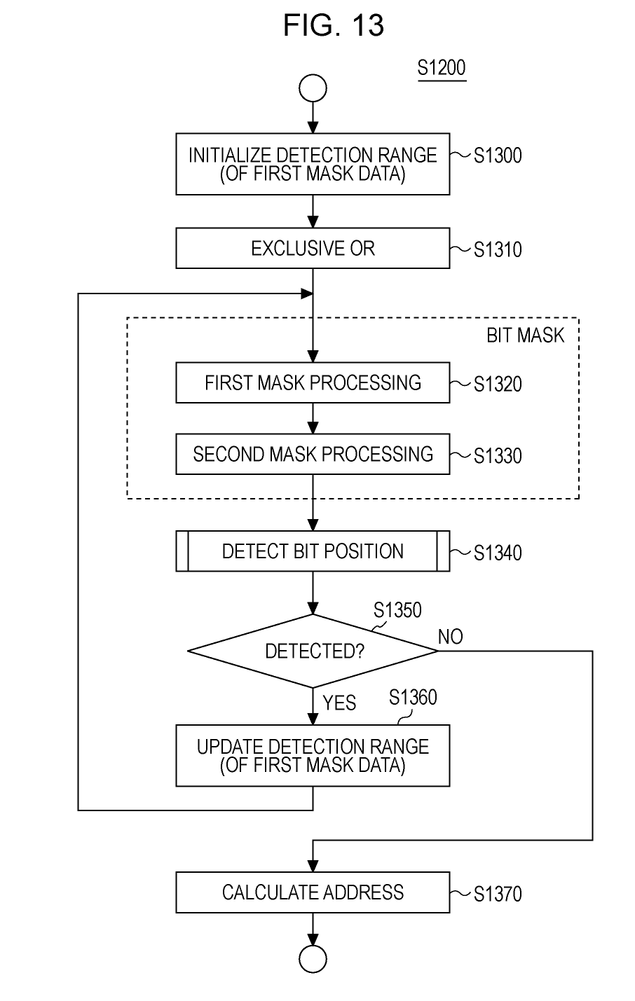

FIG. 13 shows the details of the process in step S1200. First, the controller 830 initializes first mask data indicative of a range in which a bit whose logical value is true is to be detected (S1300). At the initialization, the total range of validity data is set to the detection range. Specifically, the controller 830 sets a bit string having the same number of bits as the bit string indicative of validity data and in which all the bits have a logical value of true to the first mask section 815 as first mask data. Next, the exclusive-OR operating section 800 exclusive ORs the bit with the bit next to the bit (S1310).

Next, the bit mask section 810 masks the bit string having an array of exclusive ORs except the first bit of the bits whose logical values are true in a preset detection range. The bit masking is achieved in steps S1320 and S1330. Specifically, the first mask section 815 masks the bits of the bit string having an exclusive OR array other than those in the set detection range (S1320). That is, the first mask section 815 ANDs the bit string with the set first mask data. Then, the second mask section 818 masks the bits of the bit string masked by the first mask section 815 adjacent to the end with respect to the first bit whose logical value is true (S1330).

Then, the bit-position detecting section 820 detects the position of bits whose logical values are true in the masked bit string (S1340). Every time the bit position is detected (S1350: YES), the controller 830 sets the positions of bits adjacent to the end with respect to the bit position as a detection range (S1360). Specifically, the controller 830 generates a bit string in which the bits from the first to the bit position have a logical value of false and the bits adjacent to the end with respect to the detected bit position have a logical value of true, and sets the bit string to the first mask section 815 as new first mask data (S1360).

The calculating component 720 repeats the above process until no bit position is detected. The fact that no bit position is detected can be determined according to whether the ORs of all the bits of the bit string output by the bit mask section 810 are false “0”. If no bit position is detected (S1350: NO), that is, when scanning of the total range of the validity data has been completed, the address calculating section 840 calculates the address of the main memory 200 corresponding to each area of consecutive invalid sectors according to the bit positions detected by the above processes. The calculation process differs with the operation of the exclusive-OR operating section 800 executed to the first bit of the validity data in step S1310. Its concrete example will be shown hereinbelow:

1. The Case of Exclusive-ORing the First Bit of Validity Data with a Constant Logical Value of True

In this case, the exclusive-OR operating section 800 exclusive ORs the first bit of a bit string indicative of validity data with a constant logical value of true, and disposes it at the head of a bit string indicative of the obtained exclusive OR. The exclusive-OR operating section 800 exclusive ORs another bit of the bit string indicative of validity data with the next bit adjacent to the end, and disposes it as a bit adjacent to the end with respect to the first bit in the bit string indicative of the obtained exclusive OR.

In this case, the address calculating section 840 calculates the start address of the area of consecutive invalid sectors according to the bit position detected for the odd-numbered time by the bit-position detecting section 820. This is because the bit string detected for the odd-numbered time indicates the boundary at which invalid sectors continue from valid sectors when validity data is scanned in sequence from the top. For example, assuming that one sector has 512 bytes, the address calculating section 840 can calculate the start address by multiplying a 24-bit value by 512, the 24-bit value having higher-order (24−n) bits as the above-described higher-order address and lower-order n bits as a value indicative of the bit position.

On the other hand, the address calculating section 840 calculates the end address of the area of consecutive invalid sectors according to the bit position detected for the even-numbered time by the bit-position detecting section 820. This is because the bit string detected for the even-numbered time indicates the boundary at which invalid sectors are followed by valid sectors when validity data is scanned in sequence from the top. For example, assuming that one sector has 512 bytes, the address calculating section 840 can calculate the end address by multiplying a 24-bit value by 512, the 24-bit value having higher-order (24−n) bits as the above-described higher-order address and lower-order n bits as a value obtained by subtracting 1 from the value indicative of the bit position.

2. The Case of Exclusive ORing the First Bit of Validity Data with a Constant Logical Value of False

In this case, the exclusive-OR operating section 800 exclusive ORs the first bit of validity data with a logical value of false, and disposes it at the head of the bit string indicative of the exclusive OR. The exclusive-OR operating section 800 exclusive ORs another bit of the validity data with the next bit adjacent to the end, and disposes it as a bit adjacent to the end with respect to the first bit in the bit string indicative of the obtained exclusive OR.

In this case, the address calculating section 840 calculates the start address of the area of consecutive invalid sectors according to the bit position detected for the even-numbered time by the bit-position detecting section 820. This is because the bit string detected for the even-numbered time indicates the boundary at which invalid sectors continue from valid sectors when validity data is scanned in sequence from the top. For example, assuming that one sector has 512 bytes, the address calculating section 840 can calculate the start address by multiplying a 24-bit value by 512, the 24-bit value having higher-order (24−n) bits as the above-described higher-order address and lower-order n bits as a value indicative of the bit position.

On the other hand, the address calculating section 840 calculates the end address of the area of consecutive invalid sectors according to the bit position detected for the odd-numbered time by the bit-position detecting section 820. This is because the bit string detected for the odd-numbered time indicates the boundary at which invalid sectors are followed by valid sectors when validity data is scanned in sequence from the top. For example, assuming that one sector has 512 bytes, the address calculating section 840 can calculate the end address by multiplying a 24-bit value by 512, the 24-bit value having higher-order (24−n) bits as the above-described higher-order address and lower-order n bits as a value obtained by subtracting 1 from the value indicative of the bit position.

When the first sector is an invalid sector, the bit position detected first may be treated in a special manner. Specifically, the address calculating section 840 may calculate the end address of the area of consecutive invalid sectors which starts from the first sector of the cache segment according to the bit position detected first.

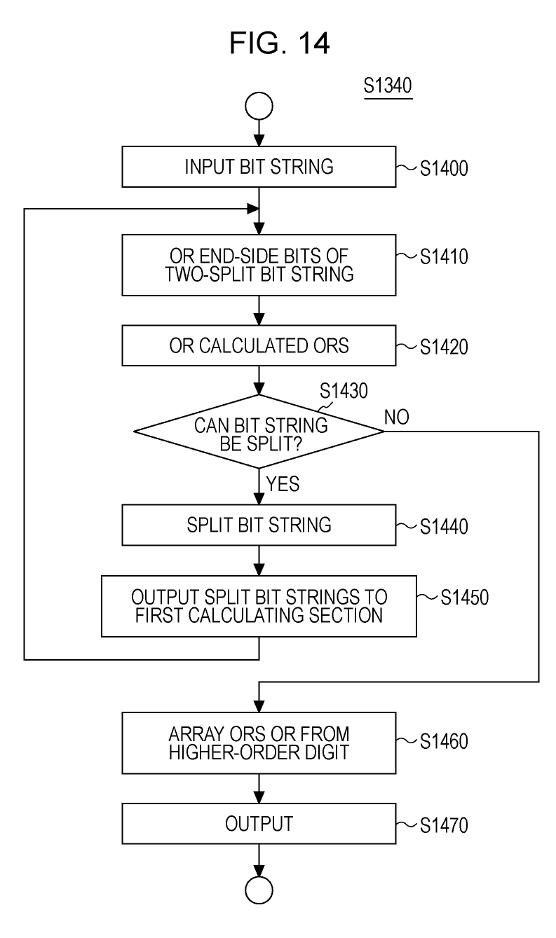

FIG. 14 shows the details of the process in step S1340. The input section 900 inputs the bit string masked by the bit mask section 810 (S1400). The first OR operating section 910 ORs the end-side bits of the two-split bit string input from the input section 900 (S1410). The second OR operating section 920, ORs the obtained ORs (S1420). The second OR operating section 920, next determines whether the input bit string can be split (S1430). For example, a 1-bit string cannot be split, but a bit string with a power of 2 can be split. Therefore, if a bit string of a power of 2 is input, it can necessarily be split.

When the bit string can be split (S1430: YES), the second OR operating section 920 splits each bit string input by the first OR operating section 910 into two (S1440). The second OR operating section 920 outputs the split bit strings to the first OR operating section 910 (S1450). In contrast, when the bit string cannot be split (S1430: NO), the output section 930 arrays the ORs obtained by the second OR operating section 920 from the top in order of operation (S1460), and outputs them as values indicative of bit positions to be detected (S1470).

The above-described process flow is one example, and various modifications can be made. For example, when the input validity data has a fixed-length bit string, it is known in advance how many times of bit-string split is needed until the bit string cannot be split. In this case, the step S1430 of determining whether the bit string can be split is not necessary. That is, in this case, the first OR operating section 910 and the second OR operating section 920 may alternately repeat the OR operations by predetermined times.

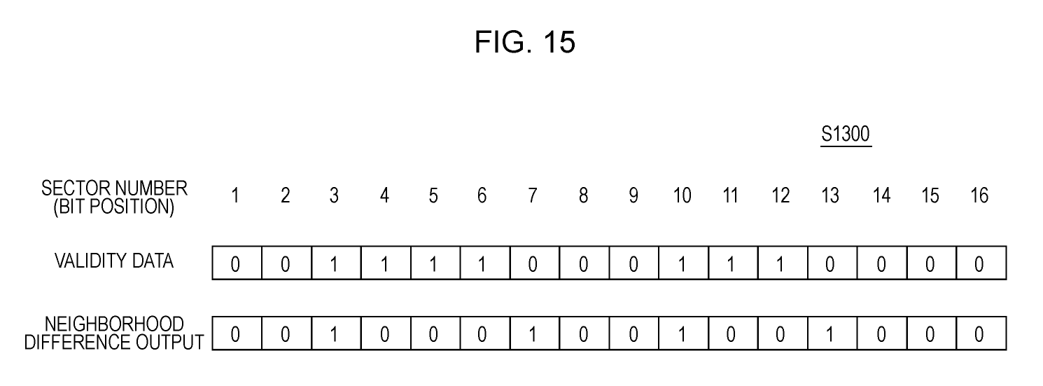

Referring next to FIGS. 15 to 20, a concrete example of the process of the calculating component 720 for certain validity data will be described.

FIG. 15 shows the details of the process for certain validity data in step S1300. Assume that validity data input by the exclusive-OR operating section 800 is a bit string “0011110001110000”. The exclusive-OR operating section 800 exclusive ORs the bits of this bit string and the other bits next to the bits. The bit string showing the obtained exclusive-ORs is referred to as neighborhood difference output.

In the example of FIG. 15, specifically, the exclusive-OR operating section 800 first exclusive ORs the first bit of the bit string indicative of the validity data with a constant logical value of false “0”, and disposes it as the first bit of the neighborhood difference output. Since the first bit of the validity data is a logical value of false “0”, the exclusive-OR of it and the constant logical value of false “0” becomes a logical value of false “0”. Next, the exclusive-OR operating section 800 exclusive ORs the other bits of the validity data with next bits adjacent to the end, and arrays them on the side adjacent to the end with respect to the first bit of the neighborhood difference output. As a result, the neighborhood difference output becomes “0010001001001000”.

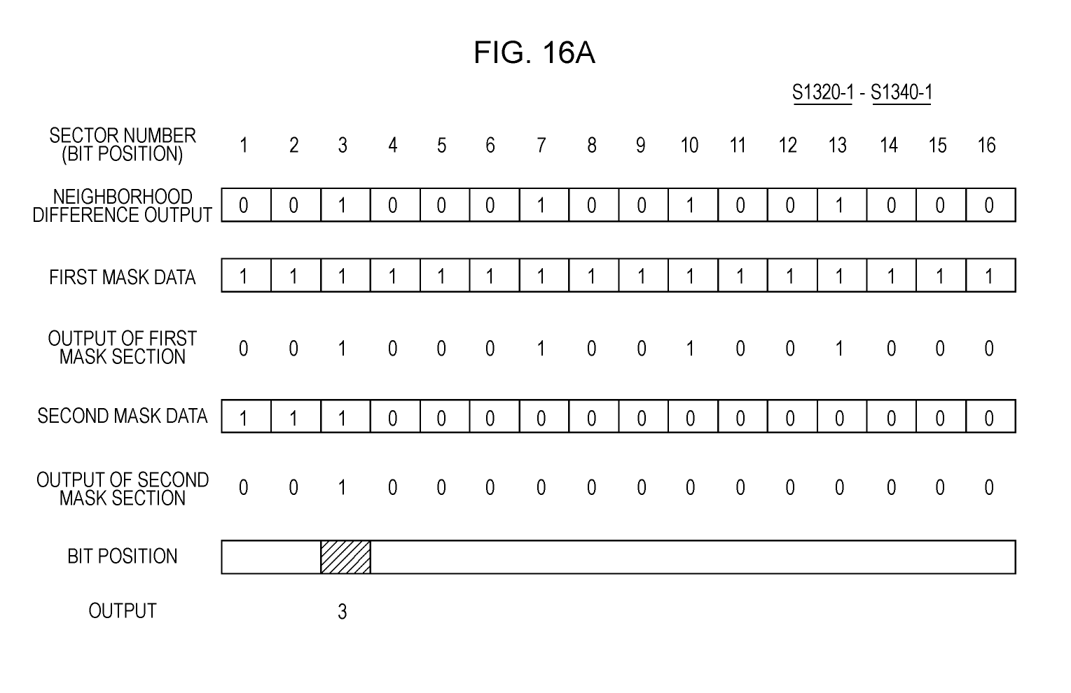

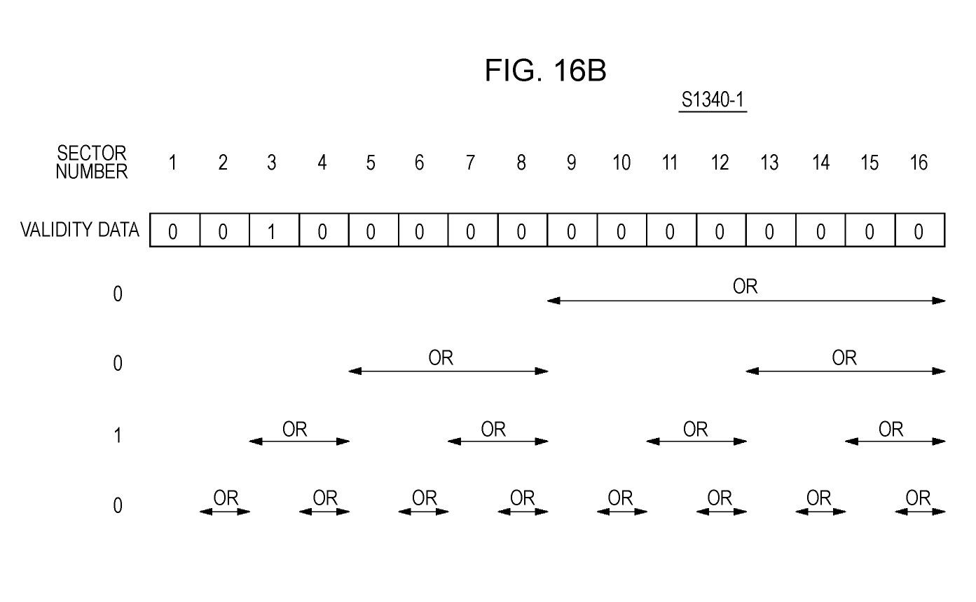

FIG. 16a shows the details of steps S1320 to S1340 of the first process of the validity data. In the first process, first mask data is set so as not to mask any bit of the validity data. Accordingly, the first mask section 815 outputs the neighborhood difference output “0010001001001000” as it is. In this output, the first bit having a logical value of true is the third bit. Accordingly, the second mask section 818 masks the bits from the fourth bit of the bit string. As a result, the second mask section 818 outputs “0010000000000000”. Thus, the bit-position detecting section 820 detects the position of a bit whose logical value is true from the output. The bit position detected is, for example, a value 3 indicative of the third bit.

FIG. 16b shows the further details of step S1340 of the first process of the validity data. The bit string input by the first OR operating section 910 is “0010000000000000”. The first OR operating section 910 splits the bit string into two, and ORs the end-side bits of the two-split bit string. Since all the end-side 9^{th} to 16^{th} bits have a logical value of false, operation results are false. Then the second OR operating section 920 ORs the obtained ORs. Since the OR calculated by the second OR operating section 920 is only one, the OR calculated by the second OR operating section 920 is the same as the OR calculated by the first OR operating section 910. The output section 930 disposes the OR at the highest-order digit of the values indicative of bit positions.

Next, the second OR operating section 920 splits the input bit string into two, and outputs the two-split bit string to the first OR operating section 910. In response to that, the first OR operating section 910 ORs the respective end-side bits of the two-split bit strings. Since all the end-side 5^{th} to 8^{th} bits have a logical value of false, the OR of the first string is a logical value of false. Since all the end-side 13^{th} to 16^{th} bits have a logical value of false, the OR of the second string is a logical value of false. Next, the second OR operating section 920 ORs the obtained ORs. The OR calculated is false. The output section 930 disposes the OR at the second digit from the highest-order digit of the values indicative of bit positions.

Next, the second OR operating section 920 splits the input two-split bit string, and outputs the two-split bit strings to the first OR operating section 910. In response to that, the first OR operating section 910 ORs the respective end-side bits of the two-split bit strings. Since the third bit of the end-side third and fourth bits has a logical value of true, the OR thereof is a logical value of true. Since all the other end-side bits have a logical value of false, the ORs thereof are false. In response to which the second OR operating section 920, ORs the logical Or operations resulting from section 910. The OR calculated is true. Then output section 930 disposes the logical value of true at the third digit from the highest-order digit of the values indicative of bit positions.

Then, the second OR operating section 920 splits the input bit string into two, and outputs the two-split bit string to the first OR operating section 910. In response to which the first OR operating section 910 ORs the respective end-side bits of the input two-split bit strings. Since all of the end-side second, fourth, sixth, eighth, 10^{th}, 12^{th}, 14^{th}, and 16^{th} bits have a logical value of false, the OR thereof is a logical value of false. In response, the second OR operating section 920, ORs the results of the logical Ors of section 910. The OR calculated is false. The output section 930 disposes the logical value of false at the fourth digit from the highest-order digit of the values indicative of bit positions.

Since the input bit string has one bit, it cannot be split more. Therefore, the second OR operating section 920 finishes the detection process. As a result, the output section 930 outputs a binary digit “0010” indicative of a bit position. The numeric value indicates 2 of a decimal number, that is, the third bit position.

As has been described with reference to FIG. 16b, when validity data contains only one bit having a logical value of true, the bit-position detecting section 820 can detect the bit position by remarkably quick processing.

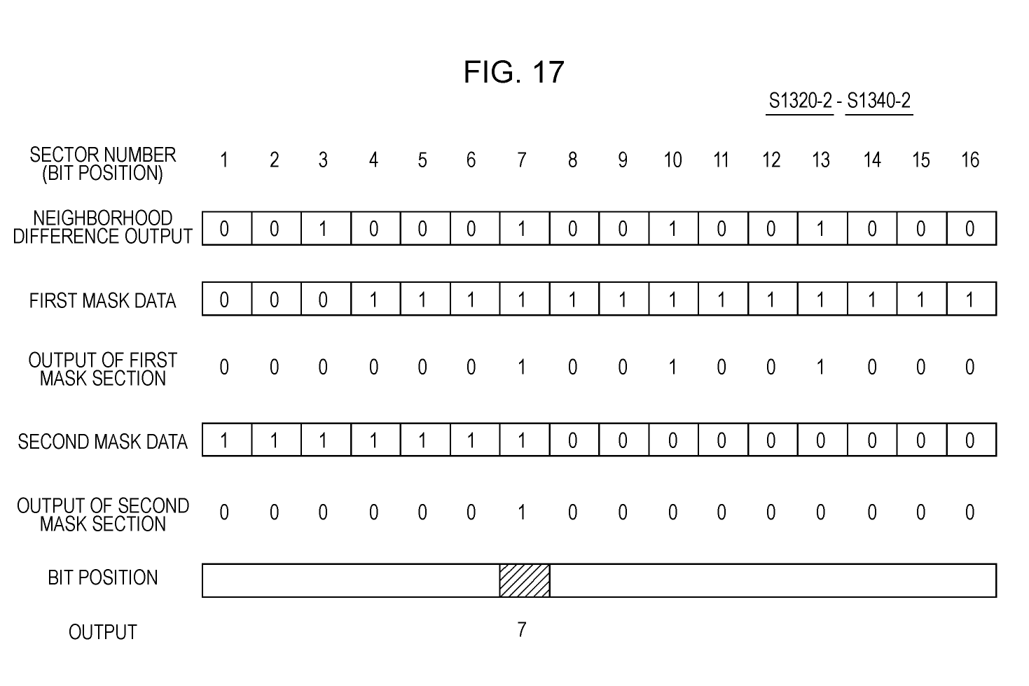

In response to the detection, the controller 830 updates the first mask data indicative of the detection range. The process based on the updated first mask data is shown in FIG. 17.

FIG. 17 shows the details of steps S1320 to S1340 of the second process of the validity data. In the second process, the first mask data is set so as to mask the first to third bits of the validity data. Accordingly, the first mask section 815 masks the neighborhood difference output “0010001001001000”, and as a result, outputs “0000001001001000”. In this output, the first bit having a logical value of true is the seventh bit. Accordingly, the second mask section 818 masks the eighth bit and the following bits of the output bit string. As a result, the second mask section 818 outputs “0000001000000000”. In response to that, the bit-position detecting section 820 detects the position of a bit whose logical value is true. The bit position detected is, for example, a value 7 indicative of the seventh bit.

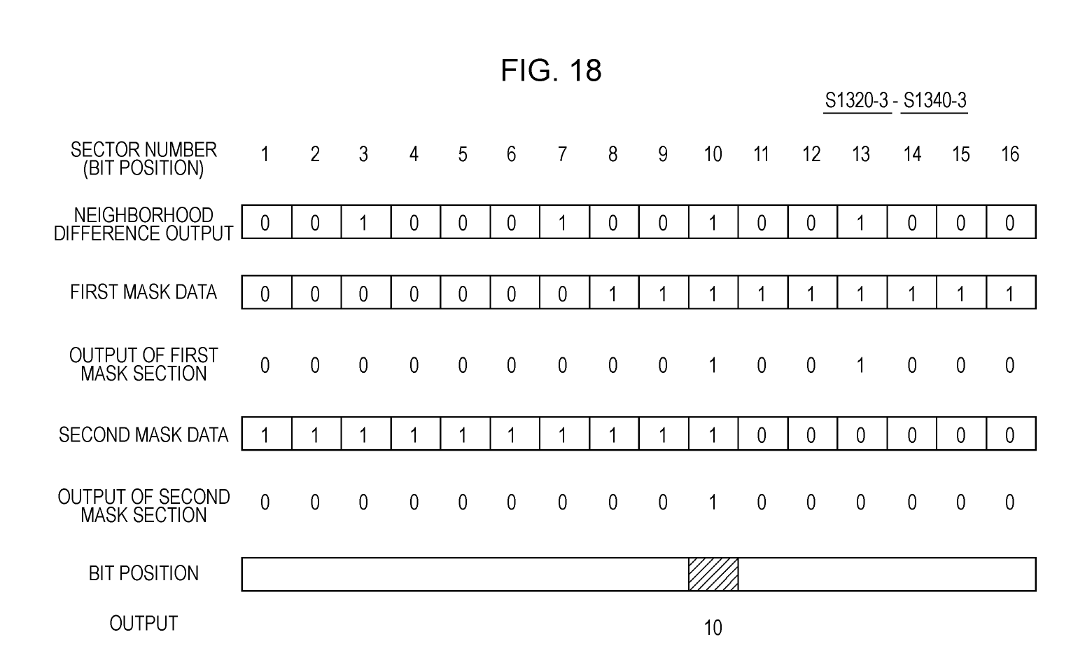

FIG. 18 shows the details of steps S1320 to S1340 of the third process of the validity data. In the third process, the first mask data is set so as to mask the first to seventh bits of the validity data. Accordingly, the first mask section 815 masks the neighborhood difference output “0010001001001000”, and as a result, outputs “0000000001001000”. In this output, the first bit having a logical value of true is the 10^{th} bit. Accordingly, the second mask section 818 masks the 11^{th} bit and the following bits of the output bit string. As a result, the second mask section 818 outputs “0000000001000000”. In response to that, the bit-position detecting section 820 detects the position of a bit whose logical value is true. The bit position detected is, for example, a value 10 indicative of the 10^{th} bit.

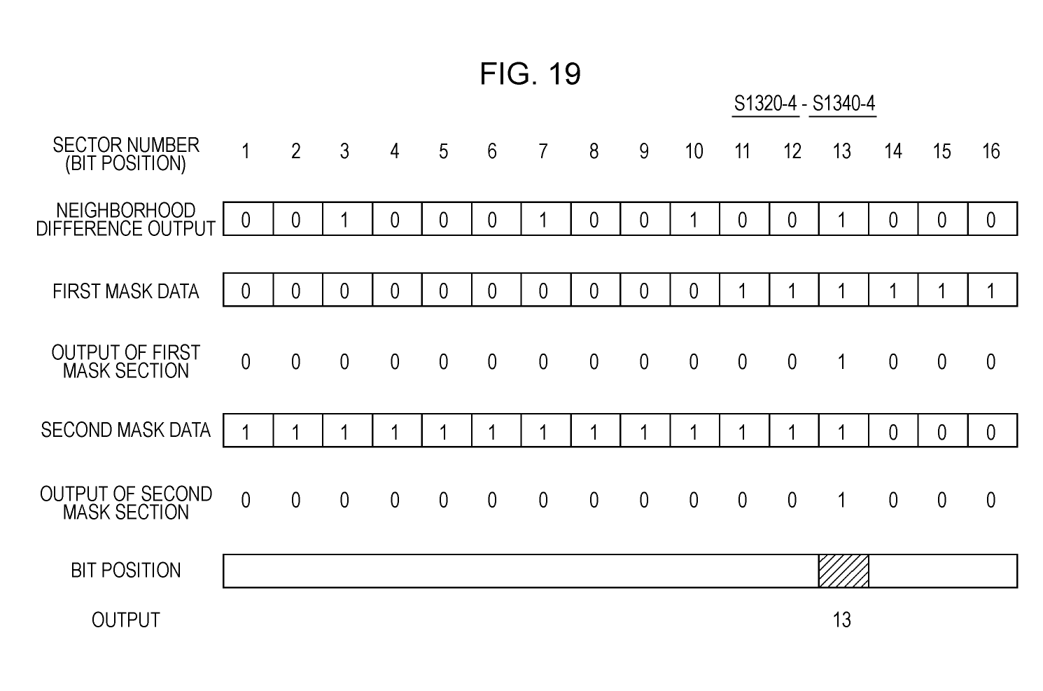

FIG. 19 shows the details of steps S1320 to S1340 of the fourth process of the validity data. In the fourth process, the first mask data is set so as to mask the first to 10^{th} bits of the validity data. Accordingly, the first mask section 815 masks the neighborhood difference output “0010001001001000”, and as a result, outputs “0000000000001000”. In this output, the first bit having a logical value of true is the 13^{th} bit. Accordingly, the second mask section 818 masks the 14^{th} bit and the following bits of the output bit string. As a result, the second mask section 818 outputs “000000000001000”. In response to that, the bit-position detecting section 820 detects the position of a bit whose logical value is true. The bit position detected is, for example, a value 13 indicative of the 13^{th} bit.

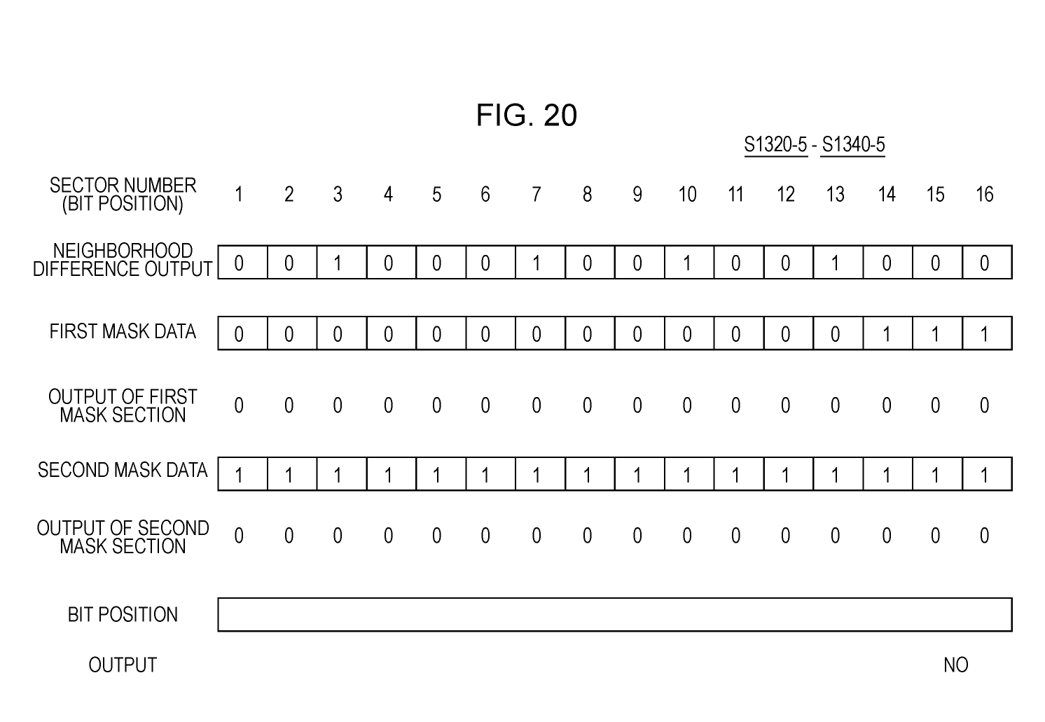

FIG. 20 shows the details of steps S1320 to S1340 of the fifth process of the validity data. In the fifth process, the first mask data is set so as to mask the first to 13^{th} bits of the validity data. Accordingly, the first mask section 815 masks the neighborhood difference output “0010001001001000”, and as a result, outputs “0000000000000000”. In this output, there is no bit having a logical value of true. Accordingly, the second mask section 818 outputs a bit string in which all the bits have a logical value of false. Thus, the bit-position detecting section 820 cannot detect the position of a bit whose logical value is true.

In place of the process shown in FIG. 16b, or in addition to the process, the bit-position detecting section 820 may OR all the bits of the bit string output from the second mask section 818, wherein when the ORs are false, the bit-position detecting section 820 may determine that no bit position can be detected. In the drawing, the fact that no bit position is detected is expressed by symbol “NO”. Instead, the bit-position detecting section 820 may output a specified value indicative of being undetectable, for example, 0 or −1. Thus, the calculating component 720 can determine that the detection on an area of consecutive invalid sectors has been completed and can finish the processing.

Next, a concrete example of the circuit structure of the calculating component 720 will be described using a case in which validity data is a 4-bit string.

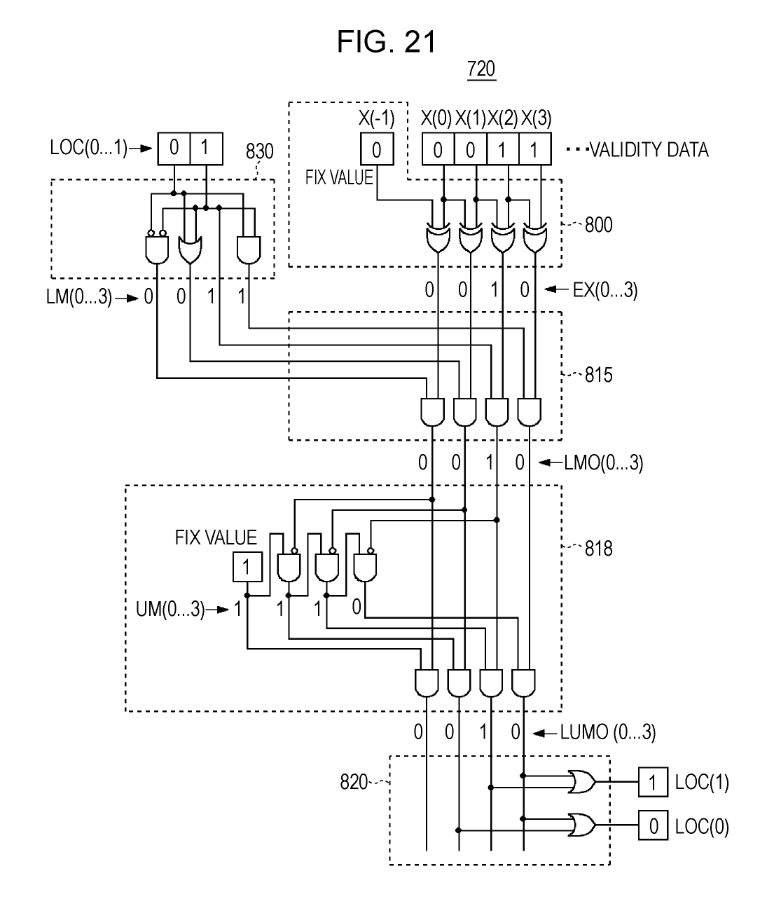

FIG. 21 shows a concrete example of the circuit structure of the calculating component 720 according to the embodiment. The calculating component 720 includes a circuit working as the exclusive-OR operating section 800, a circuit working as the first mask section 815, a circuit working as the second mask section 818, a circuit working as the bit-position detecting section 820, and a circuit working as the controller 830. The circuit working as the exclusive-OR operating section 800 includes four two-input logic gates for exclusive OR operation. Initially, the first logic gate exclusive ORs the logical value X(−1) of a constant Fix Value with the first bit X(0) of the validity data. The second logic gate exclusive ORs the first bit X(0) of the validity data with the second bit X(1). The third logic gate exclusive ORs the second bit X(1) of the validity data with the third bit X(2). The fourth logic gate exclusive ORs the third bit X(2) of the validity data with the fourth bit X(3).

The bit string having the logical values output from the logic gates becomes neighborhood difference output EX(0 to 3). In this example, the validity data is 0011, and the first bit is ORed with the constant logical value of false. Therefore, the neighborhood difference output becomes “0010”. Next, the circuit working as the first mask section 815 masks the neighborhood difference output EX(0 to 3) with “0011” that is first mask data LM(0 to 3). The masking process is achieved by an AND gate associated with each bit. As a result, “0010” that is a masked bit string LMO(0 to 3) is output.

The circuit implementing the second mask section 818 generates second mask data UM(0 to 3) that masks the end-side bits with respect to the first bit having a logical value of true in the bit string. The circuit is achieved by, for example, three AND gates and three inverters. Specifically, the circuit working as the second mask section 818 disposes the logical value of true that is the constant (Fix Value) at the first of the second mask data as it is. The circuit implementing the second mask section 818 ANDs the logical value of true that is the constant (Fix Value) with the false of the first bit of the bit string LMO. The obtained AND is disposed as the second bit of the second mask data.

The circuit implementing the second mask section 818 also ANDs the resulting AND in the previous step with the false of the second bit of the bit string (LMO). The obtained AND is then disposed as the third bit of the second mask data. Similarly, the second mask section 818 also ANDs the AND with the false of the third bit of the bit string (LMO). The obtained AND is disposed as the fourth bit of the second mask data. The second mask data thus generated becomes, for example, “1110”. The second mask section 818 masks the bit string (LMO) with this second mask data. As a result, the second mask section 818 outputs “0010” as a bit string LUMO(0 to 3).

Next, the bit-position detecting section 820 detects the position of a bit having a logical value of true from the bit string. In the example of FIG. 21, the bit-position detecting section 820 outputs a two-bit value in which the OR of the third and fourth bits of the bit string is arrayed in the higher order and the OR of the second and fourth bits of the bit string is arrayed in the lower order. For example, the value is “10” of the binary system, indicating that the bit is at the second from 0, that is, the third position. This output is input to the controller 830. The controller 830 updates the first mask data according to the output indicative of the bit position. For example, the controller 830 arrays the AND of the false of the higher-order bit and the false of the lower-order bit, the OR of the higher-order bit and the lower-order bit, the logical value itself of the lower-order bit, and the AND of the higher-order bit and the lower-order bit in that order from the top, thereby generating first mask data.

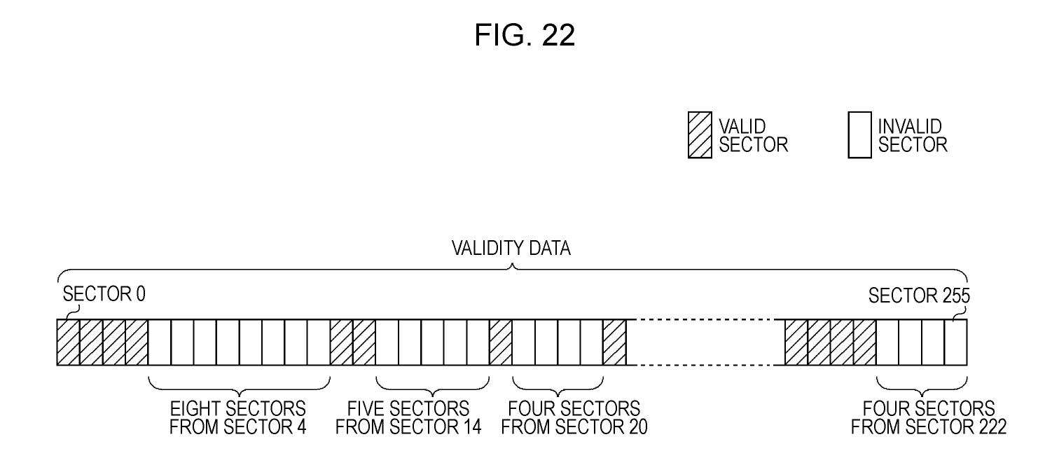

FIG. 22 shows a concrete example of an area of consecutive invalid sectors, detected from a set of validity data. The calculating component 720 according to this embodiment can specify a set of the start sector and the end sector for each area of consecutive invalid sectors, as indicated by the areas without hatch lines in FIG. 22. For example, in FIG. 22, it is detected that the eight sectors from the fourth sector, the five sectors from the 14^{th} sector, the four sectors from the 20^{th} sector, and the four sectors from the 222^{nd} sector are areas of consecutive invalid sectors.

Thus, the embodiment described with reference to FIGS. 1 to 22 allows the address of the main memory 200 corresponding to an area of consecutive invalid sectors to be calculated remarkably quickly by processing validity data with dedicated circuits. Actually, it was confirmed that the operation of the circuits can be executed within one cycle of, for example, about 100 MHz. Furthermore, the circuits can simplify the circuit structure of the function of encoding the bit string to calculate the bit position (the bit-position detecting section 820) by providing the function of masking the bits other than the bit indicative of the boundary of an area of consecutive invalid sectors (the exclusive-OR operating section 800 and the bit mask section 810), thereby reducing the overall circuit scale. Actually, it was confirmed that the circuit is small enough as a circuit for controlling access to a flash memory, so that it has a practical size in view of installation area, cost, and power consumption.

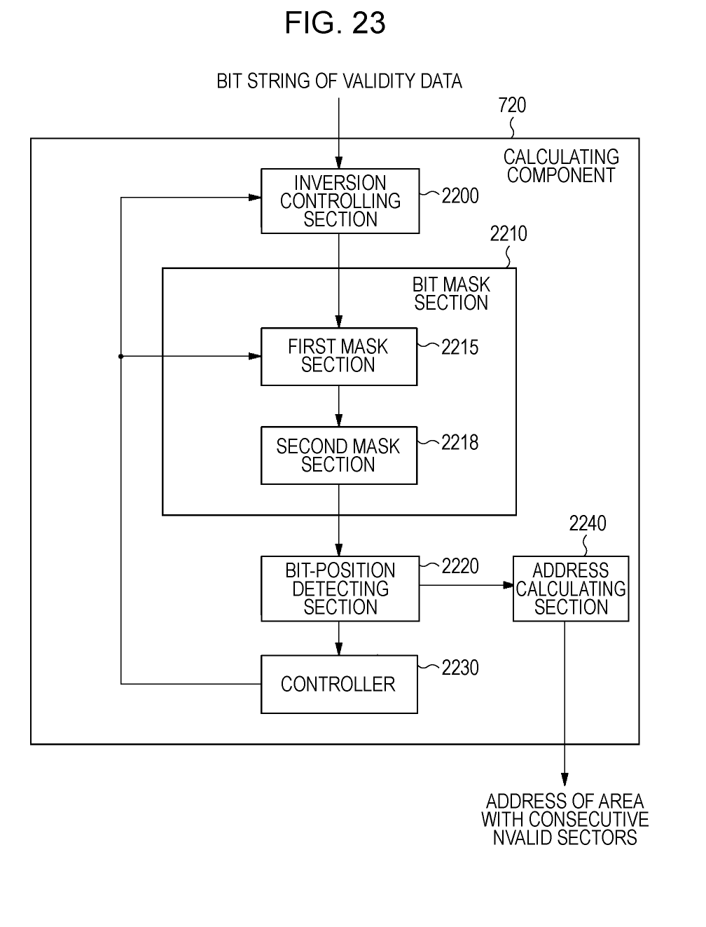

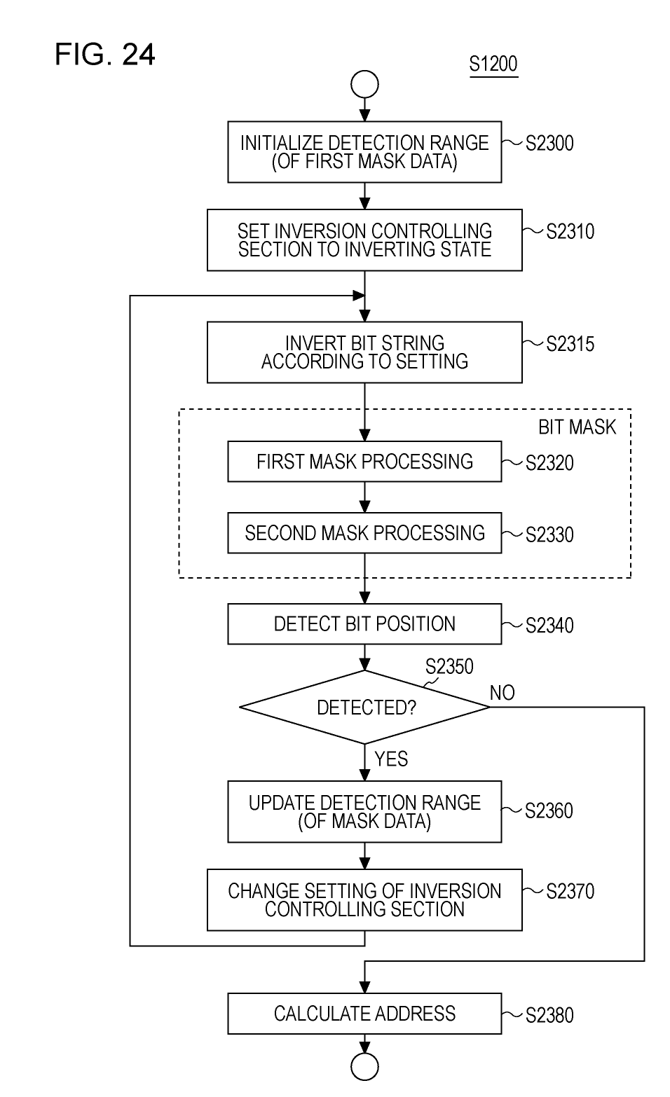

It is obvious for those skilled in the art that the detection by those circuits is one embodiment and various modifications and replacements can be used. For example, the detection of an area of consecutive invalid sectors can also be executed by a microprocessor according to a program for executing the flows of FIGS. 13 and 14. Also with the circuits, various modifications can be made so as to be adapted to various situations. One example will be described with reference to FIGS. 23 and 24.

FIG. 23 shows the functional structure of a first modification of the calculating component 720 according to the embodiment. The calculating component 720 according to the first modification has an inversion controlling section 2200 in place of the exclusive-OR operating section 800 according to the embodiment shown in FIG. 8. The calculating component 720 according to the first modification includes a bit mask section 2210, the inversion controlling section 2200, a controller 2230, and an address calculating section 2240, which have substantially the same functional structure but are denoted by different numerals. The first modification will be described with particular emphasis on differences from those of FIG. 8.

The inversion controlling section 2200 inverts or does not invert the logical values indicated by the bits of the bit string indicative of validity data according to the setting from the controller 2230, and outputs them to the bit mask section 2210. In the initial state, the inversion controlling section 2200 is set to invert logical values. The bit mask section 2210 is substantially the same as the bit mask section 810. That is, the bit mask section 2210 has a first mask section 2215 and a second mask section 2218. The first mask section 2215 masks bits of the output bit string, except the bits in the detection range set from the controller 2230. The second mask section 2218 masks the bits of the bit string masked by the first mask section 2215 adjacent to the end with respect to the first bit whose logical value is true.

Descriptions of the bit-position detecting section 2220 and the address calculating section 2240 will be omitted because they are substantially the same as the bit-position detecting section 820 and the address calculating section 840. Every time a bit position is detected by the bit-position detecting section 2220, the controller 2230 sets the bits adjacent to the end with respect to the bit position to the first mask section 2215 as a detection range. Furthermore, every time a bit position is detected by the bit-position detecting section 2220, the controller 2230 switches the inversion controlling section 2200 between inversion and noninversion. The controller 2230 repeats the processes until no bit position can be detected by the bit-position detecting section 2220.

Descriptions of the structures other than that of the calculating component 720 will be omitted here because they are substantially the same as those described with reference to FIGS. 1 to 22.

FIG. 24 shows the process flow of the calculating component 720 according to the first modification of the embodiment. First, the controller 2230 initializes first mask data indicative of the range of detection of a bit whose logical value is true (S2300). The total range of the validity data at the initialization is set as a detection range. Specifically, the controller 2230 sets a bit string having the same number of bits as that of the bit string indicative of the validity data and in which all the bits have a logical value of true to the first mask section 2215 as first mask data. Next, the controller 2230 sets the inversion controlling section 2200 to an inverting state (S2310).

The inversion controlling section 2200 inverts or does not invert the logical values indicated by the bits of the bit string indicative of the validity data according to the setting from the controller 2230, and outputs them to the bit mask section 2210 (S2315). Next, the bit mask section 2210 masks the output bit string except the first bit of the bits whose logical values are true in a preset detection range. The bit masking is achieved in steps S2320 and S2330. Specifically, first, the first mask section 2215 masks the bits of the output bit string except the bits in the set detection range (S2320). That is, the first mask section 2215 ANDs the bit string with the set first mask data. Next, the second mask section 2218 masks the bits of the bit string masked by the first mask section 2215 adjacent to the end with respect to the first bit whose logical value is true (S2330).

Next, the bit-position detecting section 2220 detects the position of a bit whose logical value is true from the masked bit string (S2340). Every time the bit position is detected by the bit-position detecting section 2220 (S2350: YES), the controller 2230 sets the position of the bits adjacent to the end with respect to the bit position to the bit mask section 2210 as a detection range. Specifically, the controller 2230 generates a bit string in which the logical values of the bits from the first to the bit position are false and those of the bits adjacent to the end with respect to the detected bit position are true, and sets the bit string to the first mask section 2215 as new first mask data (S2360). Then, the controller 2230 switches the inversion controlling section 2200 between inversion and noninversion (S2370).

The bit-position detecting section 2220 repeats the above processes until no bit position is detected. If no bit position is detected (S2350: NO), that is, when the scanning of the total range of the validity data has been completed, the address calculating section 2240 calculates the address of the main memory 200 corresponding to each area of consecutive invalid sectors according to the bit positions detected in sequence by the above processes. A description of the process of calculating the addresses will be omitted because it is substantially the same as the above-described “2. The case of exclusive ORing the first bit of validity data with a constant logical value of false.”

Thus, the first modification also allows detection of an area of consecutive invalid sectors by quick processing and with a circuit scale similar to that of the embodiment shown in FIGS. 1 to 22.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A memory apparatus that caches data to be written into a main memory, the memory apparatus comprising:
a cache memory including a plurality of cache segments, and capable of storing, for each cache segment, validity data having logical values arrayed in order of the sectors contained in each cache segment, the logical values each indicating whether or not each sector is a valid sector inclusive of valid data;
a calculating component for calculating, in the case of writing back a cache segment into the main memory, the address of the main memory corresponding to each area having consecutive invalid sectors according to validity data corresponding to the cache segment; and
a write-back controlling component issuing a read command to read data from the address of the main memory to each area of consecutive invalid sectors, making the area a valid sector, and writing back the data in the cache segment into the main memory;
wherein the calculating component including:
an exclusive-OR operating section for exclusive ORing each bit of a bit string indicative of the validity data with the next bit;
a bit mask section for masking the bit string having an array of the exclusive ORs except the first bit of bits whose logical values are true in a preset detection range;
a bit-position detecting section for detecting the position of a bit whose logical value is true in the masked bit string;
a controller setting, every time the bit position is detected, a bit position adjacent to the end with respect to the bit position to the bit mask section as the detection range, and repeating the process until no bit position is detected; and
an address calculating section for calculating the address of the main memory corresponding to each area of consecutive invalid sectors according to the bit position detected in sequence.

2. The memory apparatus according to claim 1, wherein the bit mask section further comprises:
a first mask section for masking the bits of the bit string having an array of the exclusive ORs outside the detection range; and
a second mask section for masking the bits of the bit string masked by the first mask section adjacent to the end with respect to a first bit whose logical value is true.

3. The memory apparatus according to claim 1, wherein the bit-position detecting section further comprises:
an input section for inputting the bit string masked by the bit mask section;
a first OR operating section for splitting the input bit string into two and ORing the bits of the two-split bit string adjacent to the end;
a second OR operating section for repeating the process of ORing the obtained ORs, splitting each of the input bit strings into two, and outputting the input bit strings to the first OR operating section until the bit strings cannot be split; and
an output section arraying the ORs calculated in sequence by the second OR operating section in order of the operation from the higher-order digit and outputting the ORs as numeric values indicative of the bit positions to be detected.

4. The memory apparatus according to claim 1, wherein:
for the bits comprising the validity data, a logical value of true indicates a valid sector and a logical value of false indicates an invalid sector;
the exclusive-OR operating section exclusive ORs the first bit of the validity data with a logical value of true, disposes the exclusive-OR at the head of a bit string indicative of exclusive ORs, disposes the exclusive-OR of another bit of the validity data and the next bit adjacent to the end at a position adjacent to the end with respect to the first bit; and
the address calculating section calculates the first address of an area of consecutive invalid sectors according to the bit position detected by the bit-position detecting section for an odd-numbered time, and calculates the end address of the area according to the bit position detected by the bit-position detecting section for an even-numbered time.

5. The memory apparatus according to claim 1, wherein:
for the bits comprising the validity data, a logical value of true indicates a valid sector and a logical value of false indicates an invalid sector;
the exclusive-OR operating section exclusive ORs the first bit of the validity data with a logical value of false, disposes the exclusive-OR at the head of a bit string indicative of exclusive ORs, disposes the exclusive-OR of another bit of the validity data and the next bit adjacent to the end at a position adjacent to the end with respect to the first bit; and
the address calculating section calculates the first address of an area of consecutive invalid sectors according to the bit position detected by the bit-position detecting section for an even-numbered time, and calculates the end address of the area according to the bit position detected by the bit-position detecting section for an odd-numbered time.

6. The memory apparatus according to claim 1, wherein
the cache segment is assigned to at least part of a memory block that is a unit of writing and having a data size larger than that of the cache segment; and
the write-back controlling component makes a cache segment to be written back a valid sector, reads the data corresponding to another cache segment in the memory block from the main memory, and writes back the cache segment and the read data into the memory block.

7. The memory apparatus according to claim 1, further comprising a write controlling component that assigns a new cache segment to cache write data in response to a write cache miss to a sector, writes the write data into a sector in the cache segment, and sets validity data corresponding to sectors other than the write target sector invalid.

8. The memory apparatus according to claim 7, wherein, in response to a write cache hit to a sector, the write control section writes write data into the sector in the cache segment assigned to cache the write data, and sets the validity data corresponding to the sector valid.

9. The memory apparatus according to claim 1, further comprising the main memory.

10. The memory apparatus according to claim 9, wherein the main memory includes at least one flash memory.

11. A memory apparatus that caches data to be written into the main memory, the memory apparatus comprising:
a cache memory including a plurality of cache segments, and memorizing, for each cache segment, validity data having logical values arrayed in order of the sectors in each cache segment, the logical values each indicating whether or not each sector contained in each cache segment is a valid sector inclusive of valid data;
a calculating component for calculating, in the case of writing back a cache segment into the main memory, the address of the main memory corresponding to each area having consecutive invalid sectors according to validity data corresponding to the cache segment; and
a write-back controlling component issuing a read command to read data from the address of the main memory to each area of consecutive invalid sectors, and making the area a valid sector, and writing back the data in the cache segment into the main memory;
wherein the calculating component including:
an inversion controlling section for inverting or not inverting a logical value indicated by each of the bits of the bit string indicative of validity data according to the setting, and outputting the logical values;
a bit mask section for masking the output bit string except the first bit of bits whose logical values are true in a preset detection range;
a bit-position detecting section for detecting the position of a bit whose logical value is true in the masked bit string;
a controller executing, every time the bit position is detected, the process of setting a bit position adjacent to the end with respect to the bit position to the bit mask section as the detection range and the process of switching the inversion controlling section between inversion and noninversion, and executing the processes until no bit position is detected; and
an address calculating section for calculating the address of the main memory corresponding to each area of consecutive invalid sectors according to the bit position detected in sequence.

12. A method for controlling a memory apparatus that caches data to be written into a main memory, the memory apparatus comprising:
a cache memory including a plurality of cache segments, and memorizing, for each cache segment, validity data having logical values arrayed in order of the sectors in each cache segment, the logical values each indicating whether or not each sector contained in each cache segment is a valid sector inclusive of valid data; and
the method comprising:
calculating, in the case of writing back a cache segment into the main memory, the address of the main memory corresponding to each area having consecutive invalid sectors according to validity data corresponding to the cache segment; and
issuing a read command to read data from the address of the main memory to each area of consecutive invalid sectors, making the area a valid sector, and writing back the data in the cache segment into the main memory;
the step of calculation including the steps of:
exclusive ORing each bit of a bit string indicative of the validity data with a next bit;
masking the bit string having an array of the exclusive ORs except the first bit of bits whose logical values are true in a preset detection range;
detecting the position of a bit whose logical value is true in the masked bit string;
setting, every time the bit position is detected, a bit position adjacent to the end with respect to the bit position to the bit mask section as the detection range; and
calculating the address of the main memory corresponding to each area of consecutive invalid sectors according to the bit position detected in sequence.

13. A computer program product for controlling a memory apparatus that caches data to be written into a main memory, the memory apparatus comprising:
a cache memory including a plurality of cache segments, and memorizing, for each cache segment, validity data having logical values arrayed in order of the sectors in each cache segment, the logical values each indicating whether or not each sector contained in each cache segment is a valid sector inclusive of valid data; and
the computer program product comprising:
computer usable program code for calculating, in the case of writing back a cache segment into the main memory, the address of the main memory corresponding to each area having consecutive invalid sectors according to validity data corresponding to the cache segment;
computer usable program code for issuing a read command to read data from the address of the main memory to each area of consecutive invalid sectors, making the area a valid sector, and writing back the data in the cache segment into the main memory;
computer usable program code for exclusive ORing each bit of a bit string indicative of the validity data with the next bit;
computer usable program code for masking the bit string having an array of the exclusive ORs except the first bit of bits whose logical values are true in a preset detection range;
computer usable program code for detecting the position of a bit whose logical value is true in the masked bit string;
computer usable program code for setting, every time the bit position is detected, a bit position adjacent to the end with respect to the bit position to the bit mask section as the detection range, and repeating the process until no bit position is detected; and
computer usable program code for calculating the address of the main memory corresponding to each area of consecutive invalid sectors according to the bit position detected in sequence.
